(19) United States
(12) Patent Application Publication
(10) Pub. No.: US 2008/0292331 A1
(43) Pub. Date: Nov. 27, 2008

(54) DEVELOPING APPARATUS, PROCESS CARTRIDGE AND IMAGE FORMING APPARATUS

(75) Inventors: Kanji Yokomori, Odawara-shi (JP); Yuuki Nakamura, Suntou-gun (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/941,495

(22) Filed: Nov. 16, 2007

(30) Foreign Application Priority Data
Jan. 31, 2007 (JP) 2007-022466
Nov. 8, 2007 (JP) 2007-291356

(51) Int. Cl. G03G 15/08

(52) U.S. Cl. 399/27; 399/254

(57) ABSTRACT

A developing apparatus usable with an electrophotographic image forming apparatus, the apparatus including a developer accommodating container, a developer chamber including a developer carrying member carrying and feeding a developer supplied from the container to develop an electrostatic latent image formed on an electrophotographic photosensitive member, a stirrer stirring the developer in the chamber and supplying the developer from the container into the chamber through an opening in the container, a wall surface, provided in the container, for being contacted by a free end portion of the stirrer while the stirrer moves, and a detector detecting a remaining amount of the developer. The position where the free end portion of the stirrer separates from the wall surface is above the detector and inside the container.

### FIELD OF THE INVENTION AND RELATED ART

The present invention relates to an electrophotographic image forming apparatus, a developing apparatus employed by an electrophotographic image forming apparatus, and a process cartridge removably mountable in an electrophotographic image forming apparatus.

Here, an “electrophotographic image forming apparatus” means an apparatus which forms an image on recording medium, using an electrophotographic image forming method. Examples of an electrophotographic image forming apparatus include an electrophotographic copying machine, an electrophotographic printer (laser beam printer, LED printer, etc.), a facsimile apparatus, a wordprocessor, and a multifunction apparatus capable of performing two or more functions of the preceding apparatuses, etc.

A “developing apparatus” means an apparatus which develops an electrostatic latent image on an image bearing member, such as an electrophotographic photosensitive drum, into a visible image, with the use of developer.

The process cartridge means a cartridge in which at least a developing means and an electrophotographic photosensitive drum, are integrally disposed so that they can be removably mountable in the main assembly of an electrophotographic image forming apparatus.

As has been known, an image forming apparatus, such as a copying machine, a printer, or a facsimile machine, forms an electrostatic latent image on an image bearing member, such as an electrophotographic photosensitive member, and develops the electrostatic latent image into a visible image, more specifically, a visible image formed of toner, with the use of a developing apparatus.

In the past, in the field of an image forming apparatus employing an electrophotographic image formation process, a process cartridge system has long been in use, according to which an electrophotographic photosensitive member, and one or more process cartridges which act on the electrophotographic photosensitive member, are integrally disposed in a cartridge removably mountable in the main assembly of an image forming apparatus. A process cartridge system makes it possible for a user to maintain an electrophotographic image forming apparatus without relying on a service person. Therefore, it can drastically improve an electrophotographic image forming apparatus, in terms of operability.

One of the primary reasons for process cartridge replacement is developer (toner) depletion. Thus, in order to prompt user of timely process cartridge replacement by giving in advance the user the information regarding the amount of toner remainder, some of recent electrophotographic image forming apparatuses are designed so that they detect the amount of the toner remaining in a process cartridge. There are various methods usable for detecting the amount of toner remainder.

One of the methods for detecting the amount of the toner remainder is recorded in Japanese Laid-open Patent Application 2003-131479 (FIG. 5), according to which the amount of the toner remainder is detected based on the amount of light transmission. Here, the general concept of detecting the amount of the toner remainder based on the amount of light transmission will be described with reference to a developing apparatus 104 showing in FIG. 13.

A beam of light for detecting the amount of the toner remainder (which hereafter may be referred to simply as detection light), which is emitted from a light emitting portion, such as an LED, attached to the main assembly of an image forming apparatus, is guided through a light guide (unshown) attached to the image forming apparatus or the toner container 141 of a process cartridge, and then, into the toner container 141 through a transparent window 173 of the toner container 141.

The toner container 141 is structured so that as the detection light L enters the toner container 141, it comes out, or fails to come out, of the toner container 141 through another transparent window or the like. It depends on various factors such as the amount of toner in the toner container 141 whether or not the detection beam L comes out of the toner container 141. As the detection light L of comes out of the light exit window, it is guided to a light receiving portion (unshown), such as a phototransistor, by a light guide (unshown), such as the abovementioned light guide, attached to the main assembly of the image forming apparatus, or the toner container 141. The light receiving portion is attached to the main assembly of the image forming apparatus, or the like.

Generally, there are a pair of rotational stirring members 171 and 172 in the toner container 141. The stirring members 171 and 172 are for conveying the toner in the toner container toward a development roller 140 while stirring the toner. As the detection light L enters the toner container 141 while the stirring member 171 and 172 are rotated, it is blocked by the stirring members 171 and 172 and/or the toner. The smaller the amount of toner in the toner container 141, the longer the length of time the detection light L is allowed to transmit through the toner container 141. Thus, the amount of toner (toner remainder) in the toner container 141 can be estimated by measuring the length of time the detection light L is allowed to transmit through the toner container 141. This method of detecting (estimating) the amount of the toner remainder in the toner container 141 is referred to as a toner remainder amount detecting method of the light transmission type.

The present invention is the further development of the prior art described above.

In the case of the prior art described above, as the stirring members 171 and 172 in the toner container 141 are rotated, the toner having adhered to the transparent windows 173 and 174 is removed by the stirring members 171 and 172, allowing therefore the detection light L to transmit through the toner container 141 until the toner covers again the transparent windows 173 and 174 by returning to, and accumulating on, the windows 173 and 174. If the amount of the light received by the light receiving portion, with which the main assembly of the image forming apparatus is provided, is expressed in the form of a graph, the vertical and horizontal axes of which represent the amount of the light received and the length of elapsed time, respectively, the amount of the light received by the light receiving portion changes as shown in FIG. 23; a waveform shown in FIG. 23 is obtained. As the control portion of the main assembly of the image forming apparatus receives, from the light receiving portion, the electric signals which correspond to the amount of the light received by the light receiving portion, it measures the length of the periods a1, a2, a3, . . . of time, in which the amount of the received light is no less than a preset value (threshold value). Then, based on the measured length of the periods of time, the control portion calculates (estimates) the amount of the toner remainder in the toner container 141.

However, the pattern of the changes in the amount of the light received by the light receiving portion, which is expressed in the waveform in FIG. 23, is affected by the shape of the toner container 141, the positional relationship between the transparent windows 173 and 174 and stirring members 171 and 172, etc. Therefore, the amount of the light which the light receiving portion receives does not always change in the same pattern (waveform). Thus, if the threshold value is set shown in FIG. 23, the periods a1, a2, a3, . . . become different in length, affecting thereby the accuracy with which the amount of the toner remainder in the toner container 141 can be detected.

### SUMMARY OF THE INVENTION

The present invention is made in consideration of the problem described above. Thus, the primary object of the present invention is to provide a developing apparatus, a process cartridge, and an electrophotographic image forming apparatus, the amount of the developer remainder in which can be precisely detected.

According to an aspect of the present invention, there is provide a developing apparatus for use with an electrophotographic image forming apparatus, said developing device comprising a developer accommodating chamber for accommodating a developer; a developer chamber including the developer carrying member for carrying and feeding a developer supplied from said developer accommodating chamber to develop an electrostatic latent image formed on an electrophotographic photosensitive member; a developer stirring member, rotatably provided in said developer accommodating chamber, for stirring the developer in said developer chamber then, supplying the developer from said developer accommodating chamber into said developer chamber through an opening formed in an upper part of said developer accommodating chamber; a wall surface, provided in said developer accommodating chamber, for being contacted by a free end portion of said developer stirring member while said developer stirring member is moving, wherein said developer stirring member lifts the developer toward said opening along said wall surface in said developer accommodating chamber; a developer detecting member, provided at said wall surface, for detecting a remaining amount of the developer by transmitting detecting light detected light into said developer accommodating chamber; wherein a position where the free end portion of said developer stirring member separates from said wall surface is above said developer detecting member and inside said developer accommodating chamber.

According to another aspect of the present invention, there is provide a process cartridge detachably mountable to a main assembly of an electrophotographic image forming apparatus, said process cartridge comprising an electrophotographic photosensitive member on which an electrostatic latent image is formed; a developer accommodating chamber for accommodating a developer; a developer chamber including the developer carrying member for carrying and feeding a developer supplied from said developer accommodating chamber to develop said electrostatic latent image formed on an electrophotographic photosensitive member; a developer stirring member, rotatably provided in said developer accommodating chamber, for stirring the developer in said developer chamber then, supplying the developer from said developer accommodating chamber into said developer chamber through an opening formed in an upper part of said developer accommodating chamber, when said process cartridge is mounted to the main assembly of the electrophotographic image forming apparatus; a wall surface, provided in said developer accommodating chamber, for being contacted by a free end portion of said developer stirring member while said developer stirring member is moving, wherein said developer stirring member lifts the developer toward said opening along said wall surface in said developer accommodating chamber; a developer detecting member, provided at said wall surface, for detecting a remaining amount of the developer by transmitting detecting light detected light into said developer accommodating chamber; wherein a position where the free end portion of said developer stirring member separates from said wall surface is above said developer detecting member and inside said developer accommodating chamber.

According to a further aspect of the present invention, there is provided an electrophotographic image forming apparatus for forming an image on a recording material, said apparatus comprising:

(i) a developing device including, a developer accommodating chamber for accommodating a developer, a developer chamber including the developer carrying member for carrying and feeding a developer supplied from said developer accommodating chamber to develop an electrostatic latent image formed on an electrophotographic photosensitive member, a developer stirring member, rotatably provided in said developer accommodating chamber, for stirring the developer in said developer chamber then, supplying the developer from said developer accommodating chamber into said developer chamber through an opening formed in an upper part of said developer accommodating chamber; a wall surface, provided in said developer accommodating chamber, for being contacted by a free end portion of said developer stirring member while said developer stirring member is moving, wherein said developer stirring member lifts the developer toward said opening along said wall surface in said developer accommodating chamber, a developer detecting member, provided at said wall surface, for detecting a remaining amount of the developer by transmitting detecting light detected light into said developer accommodating chamber, wherein a position where the free end portion of said developer stirring member separates from said wall surface is above said developer detecting member and inside said developer accommodating chamber; and

(ii) feeding means for feeding the recording material.

These and other objects, features, and advantages of the present invention will become more apparent upon consideration of the following description of the preferred embodiments of the present invention, taken in conjunction with the accompanying drawings.

### BRIEF DESCRIPTION OF DRAWINGS

FIG. 1 is a schematic sectional view of the image forming apparatus in the first embodiment of the present invention, showing the general structure of the apparatus.

FIG. 2 is a cross-sectional view of the process cartridge in the first embodiment of the present invention, showing the general structure of the cartridge.

FIG. 3 is a schematic perspective view of the toner stirring member.

FIG. 4 is a top view of the transparent member.

FIGS. 5(a) and 5(b) are sectional views of the transparent member, at planes A-A and B-B, respectively, in FIG. 4.

FIG. 6 is a schematic cross-sectional view of the process cartridge, showing the operation of the toner stirring member in the cartridge.

FIG. 7 is a schematic cross-sectional view of the process cartridge, showing the operation of the toner stirring member in the cartridge.

FIG. 8 is a schematic cross-sectional view of the process cartridge, showing the operation of the toner stirring member in the cartridge.

FIG. 9 is a schematic cross-sectional view of the process cartridge, showing the operation of the toner stirring member in the cartridge.

FIG. 10 is a schematic cross-sectional view of the process cartridge, showing the operation of the toner stirring member in the cartridge.

FIG. 11 is a schematic cross-sectional view of the process cartridge, showing the operation of the toner stirring member in the cartridge.

FIG. 12 is a schematic cross-sectional view of the process cartridge, showing the operation of the toner stirring member in the cartridge.

FIG. 13 is a schematic cross-sectional view of a typical process cartridge in accordance with the prior art.

FIG. 14 is a schematic cross-sectional view of the process cartridge in another (second) embodiment of the present invention, showing the general structure of the cartridge.

FIG. 15 is a perspective view of the stirring member and transparent member cleaning member of the developing apparatus in accordance with the present invention.

FIG. 16 is a schematic cross-sectional view of the developing apparatus, in the second embodiment, which is in the state in which the toner remainder amount detection light L is received by the light receiving portion.

FIG. 17 is a schematic cross-sectional view of the developing apparatus in the second embodiment, which is in the state in which the toner remainder amount detection light L is not received by the light receiving portion.

FIG. 18(a) is a horizontal sectional view a transparent member of the light transmission type, which is made up of a pair of transparent portions for detecting the amount of the toner remainder based on the amount of light transmission, and FIG. 18(b) is a vertical sectional view (at plane parallel to front panel of apparatus) of the transparent member of the light transmission type, which is made up of a pair of transparent portions for detecting the amount of the toner remainder based on the amount of light transmission.

FIG. 19(a) is a horizontal sectional view a transparent member of the light transmission type, which is made up of a pair of transparent portions for detecting the amount of the toner remainder, and FIG. 19(b) is a vertical sectional view (at plane parallel to front panel of apparatus) of the transparent member of the light transmission type, which is made up of a pair of transparent portions for detecting the amount of the toner remainder.

FIG. 20 is a cross-sectional view of the developing apparatus, which is in the state in which its light receiving portion does not receive the toner remainder amount detection light.

FIG. 21 is a cross-sectional view of the transparent member, its adjacencies, stirring sheet, and wiping sheet of the development unit, showing the relationship between the stirring sheet and wiping sheet when the wiping member begins to clean the transparent member.

FIG. 22 is a schematic sectional view (at vertical plane) of the transparent member and wiping sheet of the development unit, in the second embodiment, having a gap between the wall of the recessed portion and transparent member, when the transparent member is being cleaned, showing the developer on the wiping sheet.

FIG. 23 is a graph showing the changes (waveform) in the relationship between the amount of the developer remainder amount detection light received by the light receiving portion of the image forming apparatus in accordance with the prior art, and the elapsed time.

FIG. 24 is a graph showing the changes (waveform) in the relationship between the amount of the developer remainder amount detection light received by the light receiving portion of the image forming apparatus in the first embodiment of the present invention, and the elapsed time.

FIG. 25 is a graph showing the changes (waveform) in the relationship between the amount of the developer remainder amount detection light received by the light receiving portion of the image forming apparatus when the amount of the toner remainder in the toner storage chamber is relatively large, and the elapsed time.

FIG. 26 is a graph showing the changes (waveform) in the relationship between the amount of the developer remainder amount detection light received by the light receiving portion of the image forming apparatus when the amount of the toner remainder is the toner storage chamber is relatively small, and the elapsed time.

FIG. 27 is a schematic sectional view (at vertical plane) of the transparent member and wiping sheet of the development unit, in a comparative embodiment, having no gap between the wall of the recessed portion and transparent member, when the transparent member is being cleaned, showing the developer on the wiping sheet.

### DETAILED DESCRIPTION OF THE PREFERRED EMBODIMENTS

Hereinafter, the developing apparatus, process cartridge, and electrophotographic image forming apparatus, which are in accordance with the present invention will be described in more detail with reference to the appended drawings.

### Embodiment 1

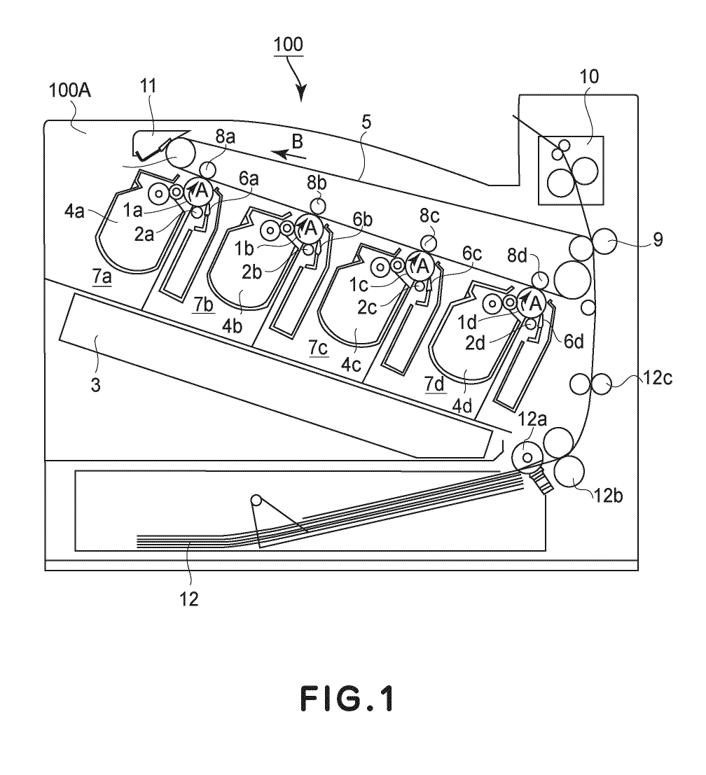

FIG. 1 is a schematic sectional view of the electrophotographic image forming apparatus in the first of the preferred embodiments of the present invention, and shows the general structure of the apparatus. The electrophotographic image forming apparatus shown in FIG. 1 is an electrophotographic color image forming apparatus. However, the application of the present invention is not limited to an electrophotographic color image forming apparatus, such as the one shown in FIG. 1. That is, the present invention is also applicable to an electrophotographic monochromatic image forming apparatus, and various electrophotographic image forming apparatuses other than the apparatus shown in FIG. 1.

First, the general structure of the electrophotographic color image forming apparatus in this embodiment will be described regarding its general structure.

### [Image Forming Apparatus]

Referring to FIG. 1, the electrophotographic color image forming apparatus 100 in this embodiment has four image bearing members, more specifically, four electrophotographic photosensitive members 1 which are in the form of a drum (which hereafter will be referred to as “photosensitive drums 1”). The multiple image bearing members are arranged side by side (juxtaposed) in parallel in a horizontal straight row. The photosensitive drum 1 is rotationally driven in the direction indicated by an arrow mark A in the drawing, by an unshown driving means. The image forming apparatus 100 is also provided with various processing means, which are in the adjacencies of the peripheral surface of the photosensitive drum 1 and are arranged in the rotational direction of the photosensitive drum 1.

More specifically, disposed in the adjacencies of the peripheral surface of each photosensitive drum 1 are a charging means 2 (2a-2d), such as a charge roller, for uniformly charging the peripheral surface of the photosensitive drum 1, and a scanner unit 3 for forming an electrostatic latent image on the peripheral surface of the photosensitive drum 1, by projecting a beam of laser light, while modulating the beam with pictorial information. Also disposed in the adjacencies of the peripheral surface of the photosensitive drum 1 are a development unit 4 (4a-4d) and an intermediary transfer belt 5. The development unit 4 is a developing apparatus, which develops an electrostatic latent image on the peripheral surface of the photosensitive drum 1 into a visible image, that is, an image formed of toner. The intermediary transfer belt 5 is a belt for transferring the toner image on the photosensitive drum 1, onto a sheet 12 of recording paper as recording medium. There is also a cleaning member 6 (6a-6d) in the adjacencies of the peripheral surface of the photosensitive drum 1. The cleaning member 6 is for removing the toner (transfer residual toner) remaining on the peripheral surface of the photosensitive drum 1 after the toner image transfer from the photosensitive drum 1.

In this embodiment, the photosensitive drum 1, and the processing means, more specifically, the charging means 2, development unit 4, and cleaning member 6, which process the photosensitive drum 1, are integrally disposed in a cartridge (process cartridge 7 (7a-7d)), which is removably mountable in the main assembly A of the electrophotographic image forming apparatus.

In this embodiment, the process cartridges 7 (7a-7d) are the same in shape, and store yellow, magenta, cyan, and black developers (which hereafter will be referred to as toner), respectively, which are nonmagnetic single component developers.

The intermediary transfer belt 5, which is an intermediary transferring apparatus, is located above the process cartridge bays of the main assembly A of the electrophotographic image forming apparatus, into which the process cartridges 7 (7a-7d) are mounted. The intermediary transfer belt 5 is in contact with the photosensitive drum 1 (1a-1d) of each process cartridge 7 (7a-7d), and rotates (circularly moves) in the direction indicated by an arrow mark B.

On the inward side of the loop which the intermediary transfer belt 5 forms, four primary transfer rollers 8 (8a-8d), as primary transferring means, are arranged in parallel so that they oppose the four photosensitive drums 1, one for one. To the primary transfer roller 8, bias which is opposite in polarity to the normal polarity to which toner is charged is applied from an unshown high voltage power source. As the primary transfer bias is applied to the primary transfer roller 8, the toner image on the photosensitive drum 1 is transferred (primary transfer) onto the intermediary transfer belt 5.

Meanwhile a recording medium 12 is conveyed, in synchronism with the movement of the intermediary transfer belt 5, by sheet conveying means, such as a sheet feeder roller 12a, sheet conveyance roller 12b and 12, etc., to the secondary transfer portion, which has a secondary transfer roller 9 as secondary transferring means. In the secondary transfer portion, the second transfer roller 9 remains pressed upon the intermediary transfer belt 5 with the presence of the recording paper 12 between the second transfer roller 9 and intermediary transfer belt 5. The secondary transfer roller 9 is the same in structured as the primary transfer roller 8. To the secondary transfer roller 9, bias which is opposite in polarity as the normal polarity to which the toner is charged, is applied from an unshown high voltage power source. As the bias is applied to the secondary transfer roller 9, the four toner images, different in color, on the intermediary transfer belt 5 are transferred together (secondary transfer) onto the recording paper 12.

After the transfer of the four toner images, different in color, onto the recording paper 12, the recording paper 12 is conveyed to the fixing apparatus 10. In the fixing apparatus 10, the toner images are fixed to the recording medium 12 by the application of heat and pressure. The residual toner remaining on the intermediary transfer belt 5 after the secondary transfer is removed by a cleaning apparatus 11, which is an apparatus for cleaning the intermediary transfer belt 5.

### [Process Cartridge]

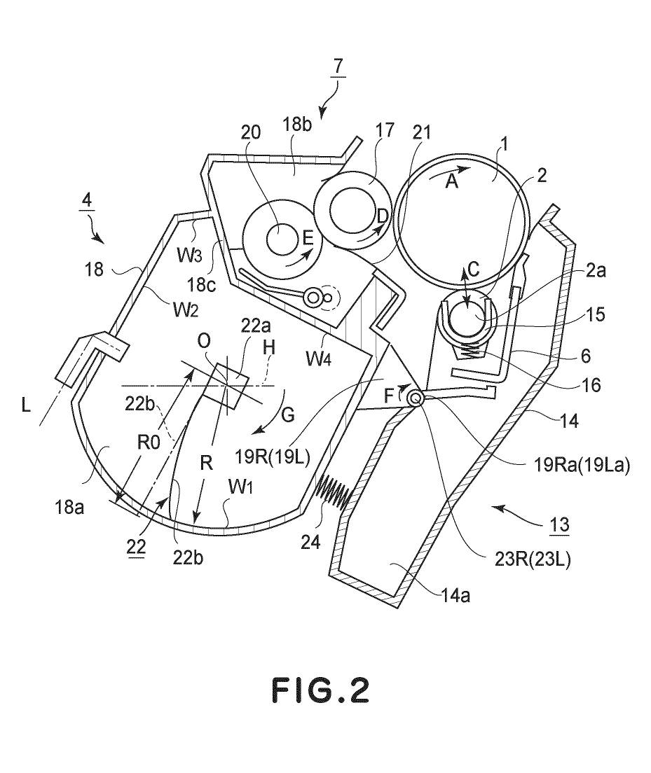

Next, referring to FIG. 2, the process cartridge 7 (7a-7d) will be described regarding its general structure. FIG. 2 is a schematic cross-sectional view of the process cartridge 7 which is in its image forming position in the main assembly 100A of the electrophotographic image forming apparatus.

In this embodiment, a cartridge 7a, which contains yellow toner, a cartridge 7b, which contains magenta toner, a cartridge 7c, which contains cyan toner, and a cartridge 7d, which contains black toner, are the same in structure.

The process cartridge 7 has a photosensitive member unit 13 made up of the photosensitive drum 1, etc., and the development unit 4 made up of the development roller 17, as a developer bearing member, etc. Next, each unit will be described.

To the cleaning means frame 14 of the photosensitive member unit 13, the photosensitive drum 1 is rotatably attached with interposition of a pair of unshown bearings. In the adjacencies of the peripheral surface of the photosensitive drum 1, the charge roller 2, and cleaning member 6 are disposed. As the residual toner is removed from the peripheral surface of the photosensitive drum 1 by the cleaning member 6, it falls into a toner chamber 14a for the removed residual toner.

As the driving force from a driving motor (unshown) is transmitted to the photosensitive member unit 13, the photosensitive drum 1 is rotationally driven in synchronism with the progression of the image forming operation. To the cleaning means frame 14, a pair of charge roller bearings 15 are attached so that the bearings 15 are movable in the direction indicated by a double-headed arrow mark C, the theoretical extension of which coincides with the axial lines of the charge roller 2 and photosensitive drum 1. The shaft 2a of the charge roller 2 is rotatably borne by the pair of charge roller bearings 15, which are kept pressured toward the photosensitive drum 1 by a pair of compression springs 16.

The developing means frame 18 of the development unit 4 has a developer storage chamber 18a (which hereafter may be referred to as toner storage chamber) and a development chamber 18b. The toner storage chamber 18a stores toner. There is a development roller 17, as a developer bearing member, in the development chamber 18b. The development roller 17 rotates in contact with the photosensitive drum 1, in the direction indicated by an arrow mark D.

In this embodiment, the development chamber 18b is above the developer storage chamber 18a. The developer storage chamber 18a and development chamber 18b are in connection to each other, through a hole 18c, with which the partition wall between the two chambers 18b and 18a is provided.

The development roller 17 in the development chamber 18b is rotatably supported by a developing means frame 18. More specifically, the development roller 17 is supported at its lengthwise end portions by a pair of bearing members (unshown) attached to the lengthwise ends of the developing means frame 18. The development unit 4 is also provided with a developer supply roller 20 (which hereafter will be referred to as toner supply roller) and a development blade 21, which are in the adjacencies of the peripheral surface of the development roller 17. The toner supply roller 20 rotates in contact with the development roller 17 in the direction indicated by an arrow mark E. The development blade 21 is for regulating in thickness the toner layer on the peripheral surface of the development roller 17.

Further, the development unit 4 has a developer stirring member 22 (which hereafter will be referred to as toner stirring member) for stirring the toner in the toner storage chamber 18a while conveying the toner to the abovementioned toner supply roller 20. The toner stirring member 22 is rotatably supported in the toner storage chamber 18a.

Referring to FIG. 2, the wall of the toner storage chamber 18a has a bottom portion W1, a first portion W2, a second portion W3, and a third portion W4. The bottom portion W1 is the portion which is at the bottom when the cartridge is in its image forming position, that is, when the attitude of the cartridge is as shown in FIG. 2. In terms of the rotational direction G of the toner stirring member 22, the first portion W2 is on the downstream side of the bottom portion W1. It is in connection to the bottom portion W1, and is tilted toward the axial line of the toner stirring member 22, relative to the vertical direction. The second portion W3 is on the downstream side of the first portion W2, and extends from the first portion W2 to the hole 18c. The third portion W4 is on the downstream side of the hole 18c, and extends from the hole 18c to the bottom portion W1.

While the toner stirring member 22 rotates in the toner storage chamber 18a across the portion of its sweeping areas, which correspond to the bottom portion W1 and first portion W2 of the wall W of the toner storage chamber 18a, the sweeping edge portion of the toner stirring member 22 moves in contact with the bottom portion W1 and first portion W2, respectively, of the toner storage chamber wall, as will be described later in detail. Thus, as the toner stirring member 22 rotates, the body of toner T in the toner storage chamber 18a is upwardly conveyed from the area corresponding to the bottom portion W1 to the area corresponding to the first portion W2, and then, is guided to the hole 18c along the second portion W3.

The portion of the body of toner T, which failed to be guided into the hole 18c, falls down, or is guided inward of the toner storage chamber 18a along the third portion W4.

The development unit 4 is pivotally connected to the photosensitive member unit 13. More specifically, the lateral plates 19R and 19L of the development unit 4 are provided with holes 19Ra and 19La, respectively. Further, a pair of connective pins 23R and 23L are put through the holes 19Ra and 19La and the corresponding holes of the photosensitive member unit 13 so that the development unit 4 is pivotally movable relative to the photosensitive member unit 13. As described above, the development unit 4 is under the pressure from compression springs 24 for pressing the development unit 4. Therefore, when the process cartridge 7 is being used for image formation, and therefore, as an image forming operation begins, the process cartridge 7 is pivoted about the connective pins 23 in the direction indicated by an arrow mark F, whereby the development roller 17 is placed in contact photosensitive drum 1.

### [Structure Arrangement for Detecting Amount of Toner Remainder]

Next, referring to FIGS. 2-5, the detection of the amount of the developer remainder in the toner storage chamber 18a (which hereafter may be referred to simply as toner remainder detection), in this embodiment, will be described.

Referring to FIG. 2, the toner stirring member 22 is in the toner storage chamber 18a which stores toner. It conveys toner to the toner supply roller 20 by being rotated in the direction G.

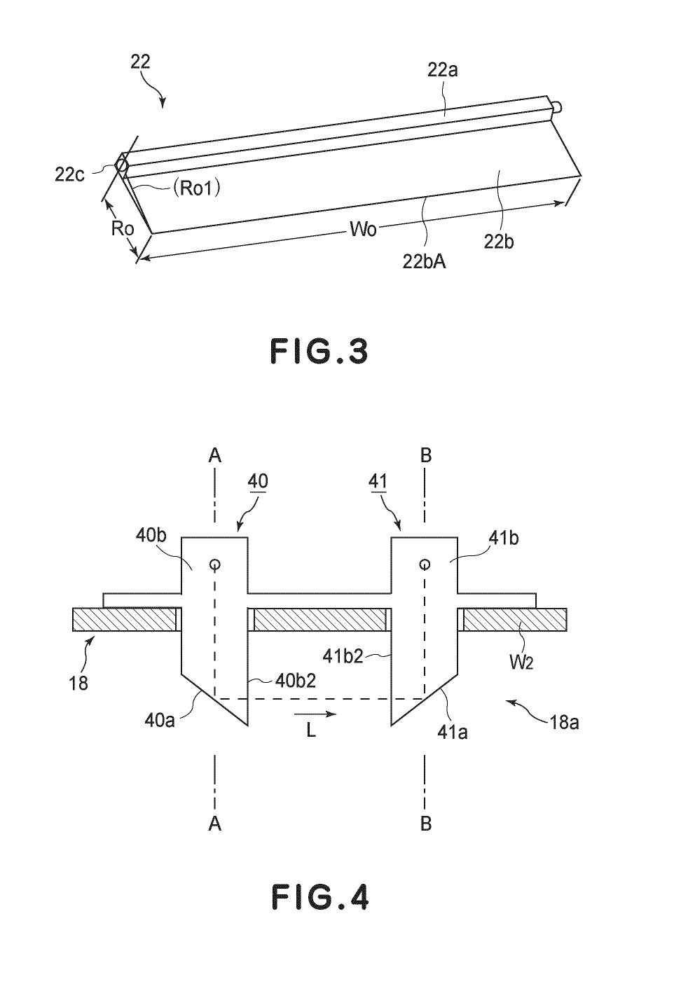

Referring to FIG. 3, the toner stirring member 22 is made up of a shaft 22a and a stirring sheet 22b. The shaft 22a is molded of a resinous substance. The stirring sheet 22b is attached to the shaft 22a by one of the longer edges. It is the very portion of the toner stirring member 22 that stirs toner. It can be easily made of flexible resinous sheet, such as polyester film, polyphenylene sulfide film, or the like. The thickness of the stirring sheet 22b is desired to be in a range of 50-250 μm.

In order to ensure that the stirring member 22 stirs and conveys even the toner in the bottom portion of the toner storage chamber 18a, the length RO of the shorter edges of the stirring sheet 22b is made greater than the distances from the rotational axis O of the stirring member 22 to the internal wall of the toner storage chamber 18a, in particular, the internal surfaces of the portions W1, W2, and W3 of the toner storage chamber wall W. The length W0 of the longer edges of the stirring sheet 22b is made to be the same as the distance between the internal surfaces of the lateral walls (end walls in terms of rotational axis of stirring member 22) of the toner storage chamber 18a.

The force for driving the stirring member 22 is transmitted to the stirring member 22 by a driver gear (unshown) attached to one of the lengthwise ends of the shaft 22a; the shaft of the driver gear is inserted in the hole 22c with which one of the lengthwise ends of the shaft 22a is provided, through the hole with which the lateral wall of the toner storage chamber 18a of the developing means frame 18 is provided.

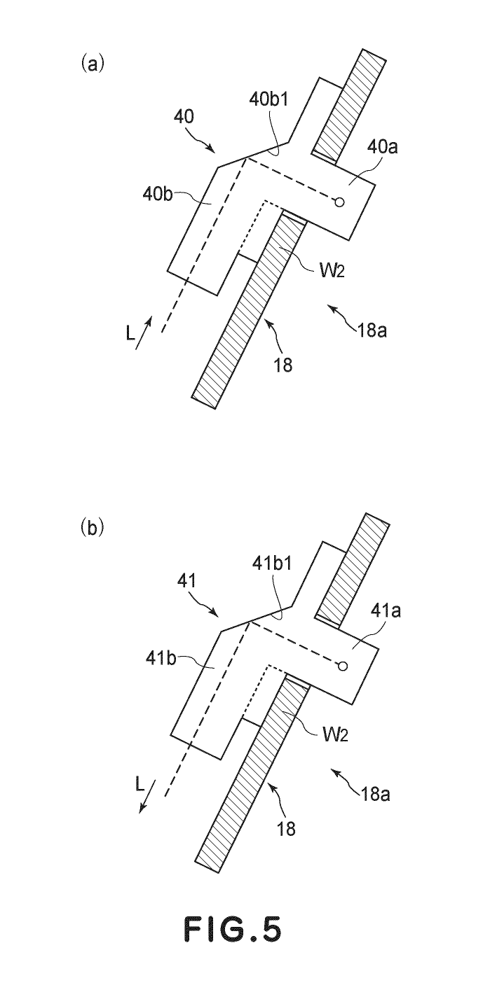

Further, the toner storage chamber 18a is provided with a toner remainder amount detecting means of the light transmission type, which is for detecting the amount of the toner remaining in the toner storage chamber 18a. More specifically, referring to FIGS. 4, 5(a), and 5(b), in this embodiment, the development unit 4 is provided with a pair of transparent members 40 and 41, of which the toner remainder amount detecting means (developer amount detecting means) is made. The transparent members 40 and 41 are attached to the first portion W2 of the wall of the toner storage chamber 18a of the developing means frame 18, as will be described later. The transparent members 40 and 41 are aligned in the direction parallel to the lengthwise direction of the development roller 17. It is preferred that the transparent members 40 and 41 are positioned above the horizontal plane which coincides with the rotational axis of the toner stirring member 22.

The transparent member 40 has a light exit portion 40a, through which the detection light L exits from the transparent member 40, whereas the transparent member 41 has a light entrance portion 41a, through which the detection light L enters the transparent member 41.

The transparent member 40 has the light exit portion 40a and a light guide portion 40b. The light guide portion 40b guides the detection light L emitted from an LED (unshown), as a light emitting portion, with which the main assembly 100A of the electrophotographic image forming apparatus is provided. The light exit portion 40a and light guide portion 40b are integral portions of the transparent member 40.

The transparent member 41 has the light entrance portion 41a and a light guide portion 41b. The light guide portion 41a guides the detection light L to a phototransistor (unshown), as a light receiving portion, with which the main assembly 100a of the electrophotographic image forming apparatus is provided, after the detection light L transmits through the toner storage chamber 18a.

Incidentally, referring to FIG. 5(a), in order to guide the detection light L from the LED, into the toner storage chamber 18a, the light guide portion 40b is provided with a reflective intermediary surface 40b1. Further, referring to FIG. 4, the light exit surface 40b2 of the light guide portion 40b squarely faces the light entrance surface 41b2 of the light entrance portion 41b. Similarly, the light guide portion 41b is provided with a reflective surface 41b1 so that the light having entered the light guide portion 41b through the light entrance surface 41b2 is guided to a phototransistor (unshown), as shown in FIG. 5(b).

### [Method for Detecting Amount of Toner Remainder]

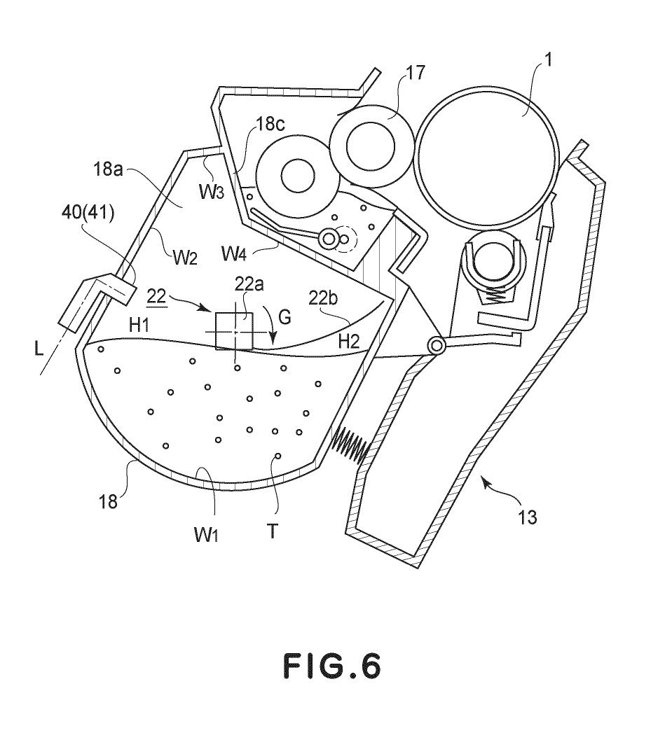

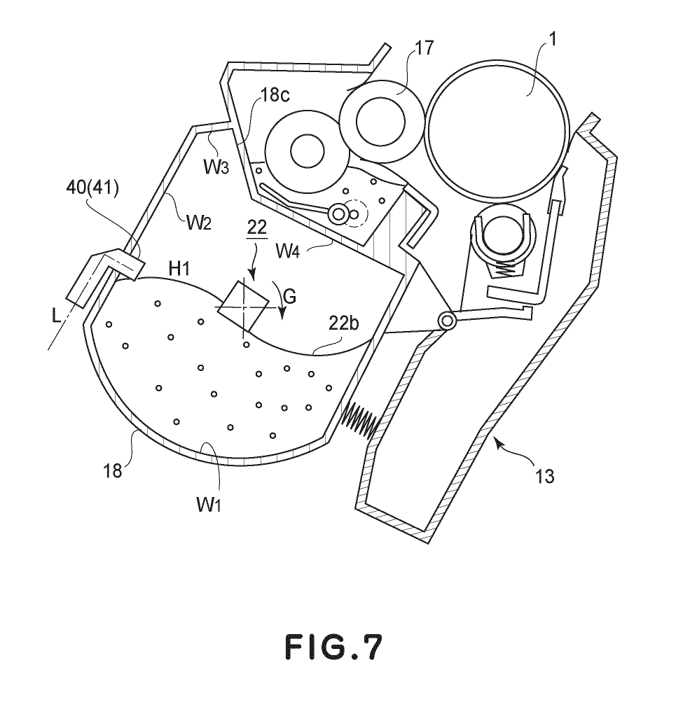

Next, referring to FIGS. 6-12, and 24, the method for detecting the amount of toner remainder will be described in detail.

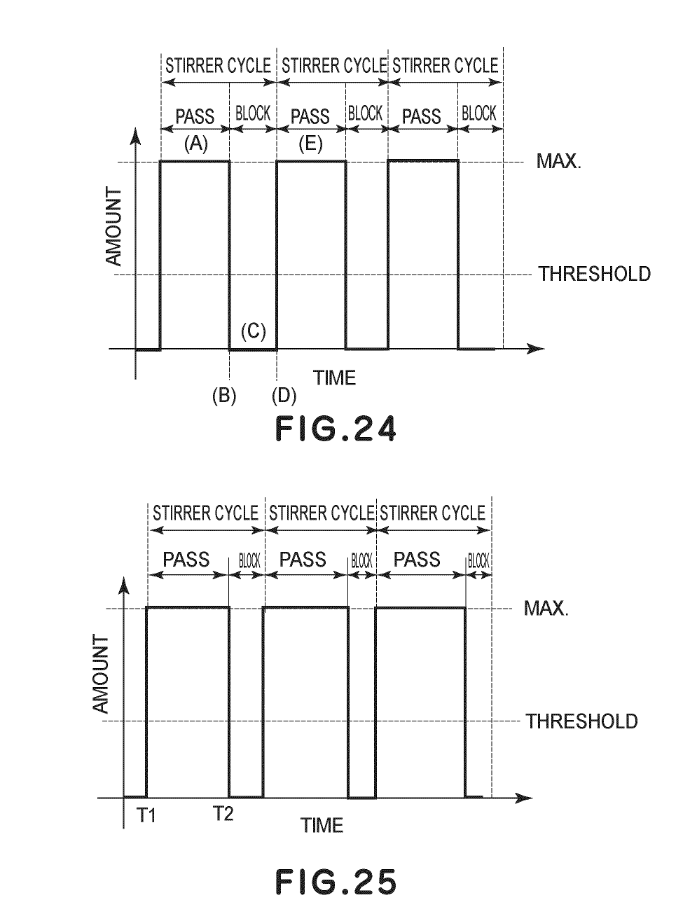

FIG. 6 is a cross-sectional view of the development unit 4, which is in the state in which the amount of the toner in the storage chamber 18a is greater than a preset value, and in which the toner stirring member 22 is above the portion H2 of the top surface of the body of toner T in the toner storage chamber 18a. FIG. 24 shows the relationship between the amount of light received by the phototransistor, and the elapsed time. The phototransistor outputs to the control portion (unshown) of the image forming apparatus main assembly (unshown), electrical signals which correspond to the amount of light it receives. As the control receives the electrical signals, it measures the duration of the period of time in which the amount of light which the phototransistor received is greater than a preset value (threshold value). Then, it calculates (estimates) the amount of the toner remainder in the toner storage chamber 18a from the measured duration.

The portion A of the waveform (pattern) of the graph, in FIG. 24, which shows the changes in the abovementioned relationship between the amount of light received by the phototransistor and the elapsed time, corresponds to the state of the development unit 4 shown in FIG. 6. That is, the top surface of the body of toner in the toner storage chamber 18a is below the vertical position of transparent members 40 and 41. Therefore, the detection light L is allowed to transmit through the space between the transparent members 40 and 41, in the toner storage chamber 18a.

As the stirring member 22 is rotated when the development unit 4 is in the state shown in FIG. 6, the stirring sheet 22b presses on the portion H2 of the top surface of the body of toner T in the toner storage chamber 18a, that is, the portion of the top surface of the body of toner T, which is on the right-hand side of the axial line of the stirring member 22, in FIG. 6. Therefore, the portion H1 of the top surface of the body of toner T, that is, the portion on the left-hand side of the axial line of the stirring member 22 rises.

The portion H1 of the top surface of the body of toner T rises along the portion W2, that is, the slanted portion, of the wall of the toner storage chamber 18a, eventually reaching the transparent members 40 and 41 as shown in FIG. 7.

Immediately after the portion H1 of the top surface of the body of toner T reaches the transparent members 40 and 41, the detection light L emitted from the LED (unshown) begins to be blocked by the body of toner T which enters the space between the pair of transparent members 40 and 41 which is attached to the wall of the toner storage chamber 18a. As a result, the phototransistor (unshown) is prevented from receiving the detection light L (state corresponding to point (B) in graph in FIG. 24).

As the toner stirring member 22 is further rotated, the portion H1 of the top surface of the body of toner T rises along the portion W2 of the internal surface of the toner storage chamber 18a, becoming thereby angled (V) relative to the horizontal plane.

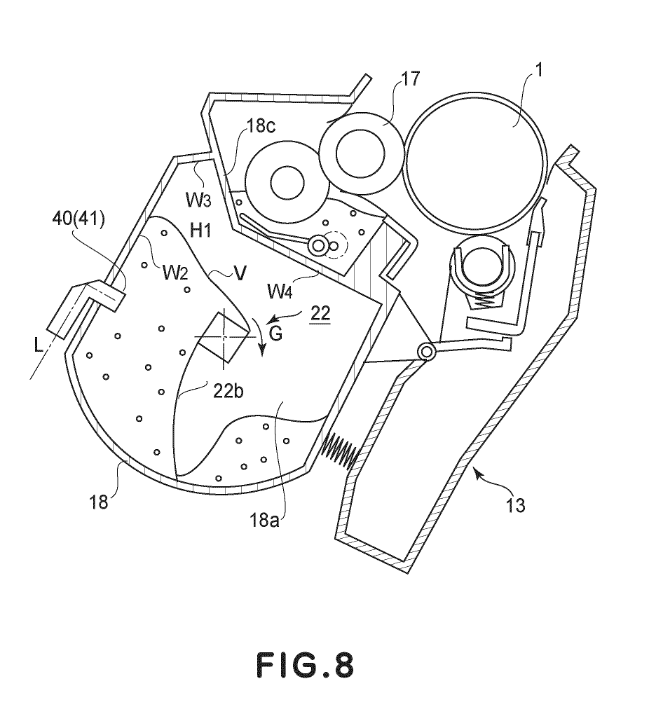

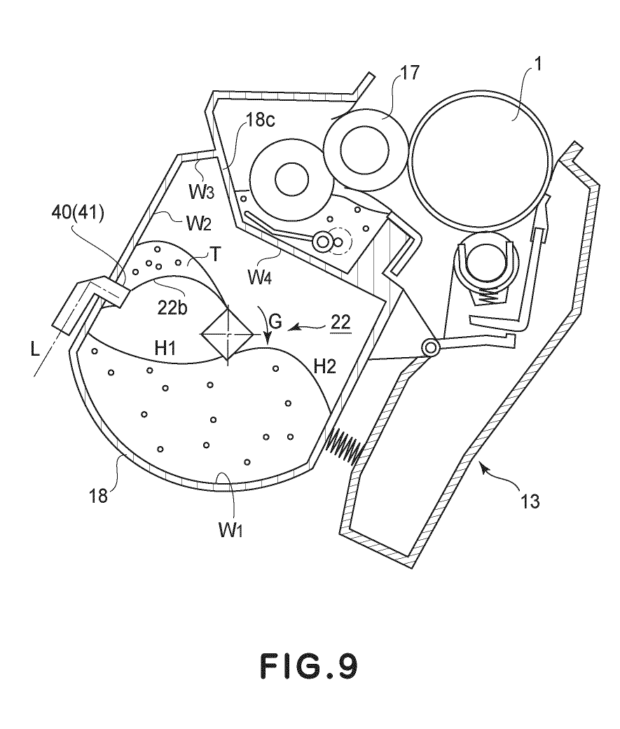

As the angle V of the portion H1 of the top surface of the body of toner T being pressed by the toner stirring sheet 22b becomes as steep as shown in FIG. 8, the body of toner T begins to partially break away and fall from the toner stirring sheet 22b, accumulating again in the bottom portion of the toner storage chamber 18a.

At the beginning of the breakaway of the body of toner T, there is still a part of the body of toner T, between the pair of transparent members 40 and 41 attached to the portion W2 of the wall of the toner storage chamber 18a, and therefore, the detection light L remains blocked as shown in FIG. 24 (state corresponding to portion (C)).

When the development unit 4 is in the state shown in FIG. 9, the stirring sheet 22b has just moved past the space between the transparent members 40 and 40 due to the rotation of the toner stirring member 22.

That is, when the development unit 4 is in the state shown in FIG. 9, the body of toner T, which has been pushed up along the internal surface of the portion W2 of the wall of the toner storage chamber 18a by the rotation of the toner stirring member 22 partially remains on the stirring sheet 22b. However, since the stirring sheet 22b has just moved past the space between the transparent members 40 and 41 with which the portion W2 of the wall of the toner storage chamber 18a is provided, there is no toner between the two transparent members 40 and 41, allowing thereby the detection light L to transmit through the space between the two transparent members 40 and 41 as shown in FIG. 24 (state corresponding to portion (D) of graph).

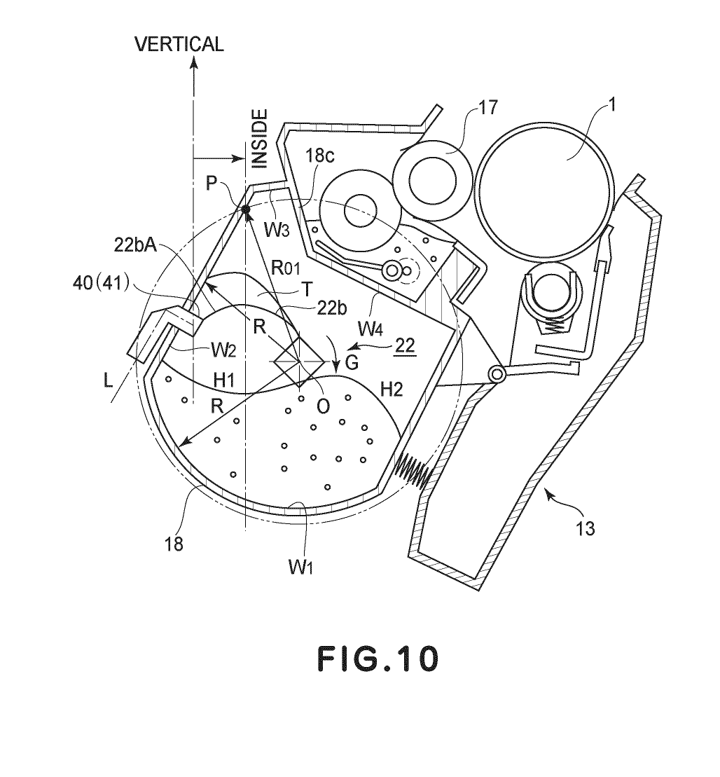

Incidentally, referring to FIG. 10, in this embodiment, the portion W2 of the toner storage chamber wall is tilted toward the axial line of the toner stirring member 22 relative to the vertical plane. Further, in this embodiment, the portion W2 is flat. However, the portion W2 may be curved inward of the toner storage chamber 18a.

Thus, while the remaining body of toner T on the stirring sheet 22b is pushed up along the portion W2 of the toner storage chamber wall, it does not occur, as shown in FIG. 24, that the remaining body of toner T blocks the detection light L by falling from the stirring sheet 22b, that is, it does not occur that the falling body of toner T prevents the detection light L from transmitting through the space between the transparent members 40 and 41 (state corresponding to portion (E) of graph in FIG. 24).

In this embodiment, the length RO (FIG. 3) of the shorter edges of the stirring sheet 22b (which is roughly the same as distance R01 from rotational axis O of toner stirring member 22 to sweeping edge 22bA of stirring sheet 22b), is greater than the distance from the axial line O of the stirring member 22 to the internal surface of the portion W2 of the toner storage chamber wall, as described above. Therefore, the possibility that the body of toner T, which is on the stirring sheet 22b, partially falls through the gap between the stirring sheet 22b and the internal surface of the portion W2 of the toner storage chamber wall is minimized.

Then, as the toner stirring member 22 is further rotated, the toner stirring sheet 22b continues to convey the toner along the portion W2 of the toner storage chamber wall, until the sweeping edge 22bA of the toner stirring sheet 22b separate from the portion W2, at a point P.

As soon as the sweeping edge 22bA (FIG. 3) of the toner stirring sheet 22b moves past the point P, the distance R from the rotational axis of the toner stirring member 22 to the internal surface of the toner storage chamber wall W becomes greater than the radius RO1 of the sweeping area of the toner stirring sheet 22b. Thus, the toner stirring sheet 22b, which has been rotated, while remaining elastically bent, instantly straightens, catapulting thereby the body of toner T on the toner stirring sheet 22b at the same time.

According to this embodiment, the development unit 4 is structured so that when the process cartridge 7 is in its image forming position in the main assembly of the image forming apparatus, the point P is on the inward side of the toner storage chamber 18a relative to the vertical plane coinciding with the most inward edges of the transparent members 40 and 41 with which the portion W2 of the toner storage chamber wall is provided. Therefore, it does not occur, as described above, that the remaining body of toner T on the toner stirring sheet 22b falls directly onto the transparent members 40 and 41. Therefore, it does not occur that while the sweeping edge 22bA of the toner stirring sheet 22b is moving across the portion of the internal surface of the toner storage chamber wall, which is between the transparent members 40 (41) and point P in terms of the rotational direction of the toner stirring member 22, the detection light L remains blocked by the toner. That is, the amount by which the phototransistor receives the detection light L is unlikely to be affected by the falling toner, as will be evident from the pattern (waveform) of the changes in the relationship between the amount of the detection light L received by the light receiving portion, and the elapsed time, shown in the graph in FIG. 24. Therefore, the threshold value for precisely determine the amount of the toner remainder can be easily set.

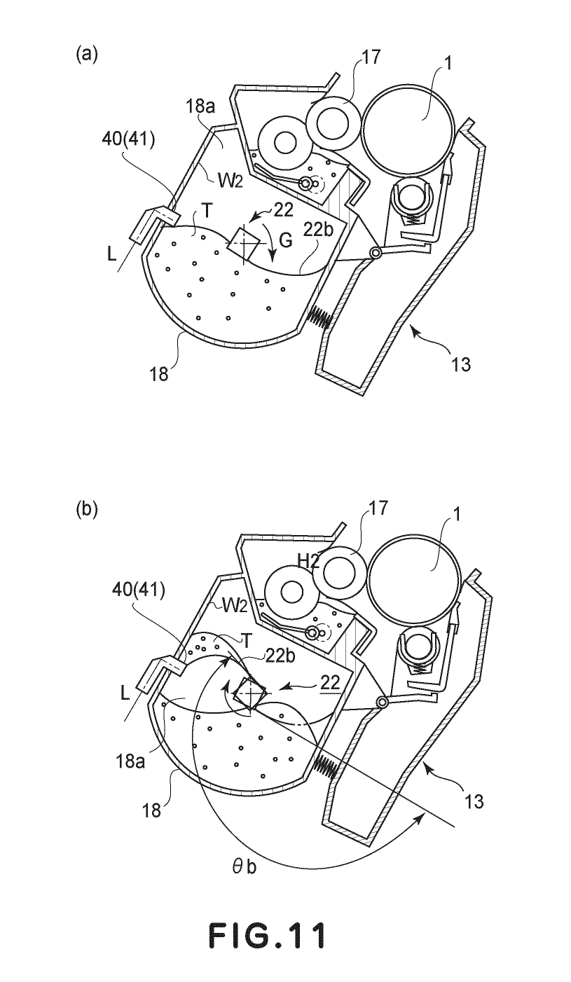

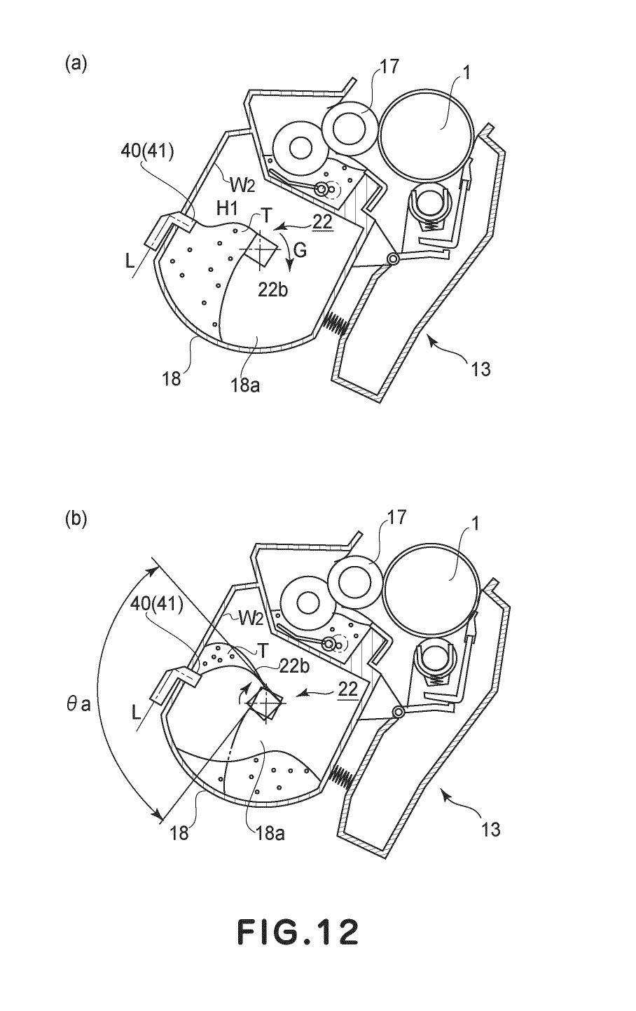

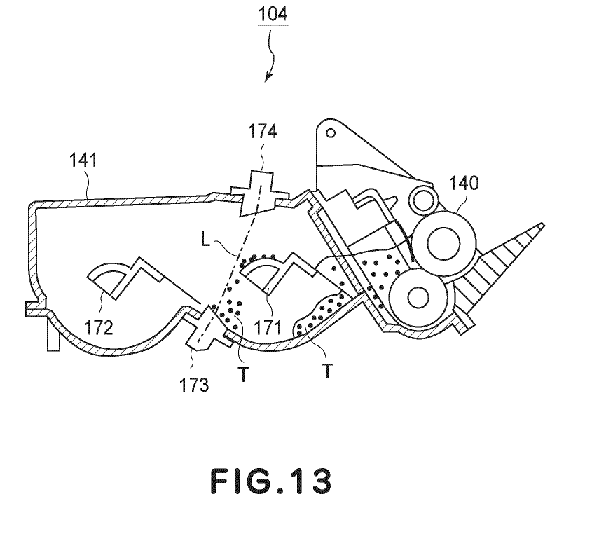

Next, referring to FIGS. 11 and 12, the changes in the length of time the detection light L remains blocked, which is caused by the changes in the amount of the toner remainder in the toner storage chamber 18a, will be described.

FIGS. 11(a) and 11(b) correspond to the case in which the amount of the toner remaining in the toner storage chamber 18a is relatively large. FIG. 25 shows the relationship (waveform) between the amount of detection light L which the phototransistor (unshown) receives when the amount of the toner remaining in the toner storage chamber 18a is relatively large, and the elapsed time.

FIG. 11(a) is a cross-sectional view of the development unit 4, which corresponds to a point T1 (FIG. 25) in elapsed time, at which the body of toner T has just reached the transparent members 40 and 41 by being pushed by the toner stirring sheet 22b. As will evident from FIG. 25, the point T1 in elapsed time is the point in time at which the detection light L, which has been allowed to transmit through the space between the transparent members 40 and 41, has just begun to be blocked by the body of toner T.

FIG. 11(b) is a cross-sectional view of the development unit 4, which corresponds to a point T2 (FIG. 25) in elapsed time, at which the toner stirring sheet 22b has just moved past the space between the transparent members 40 and 41. As will evident from FIG. 25, the point T2 in elapsed time is the point in elapsed time at which the body of toner T on the toner stirring sheet 22b has just moved out of the space between the transparent members 40 and 41 with which the portion W2 of the toner storage chamber wall is provided, that is, the point in elapsed time at which the detection light L has just begun to transmit again through the space between the transparent members 40 and 41.

While the state of the process cartridge 7 changes from the state shown in FIG. 11(a) to the state shown in FIG. 11(b), the toner stirring member 22b rotates by an angle θb.

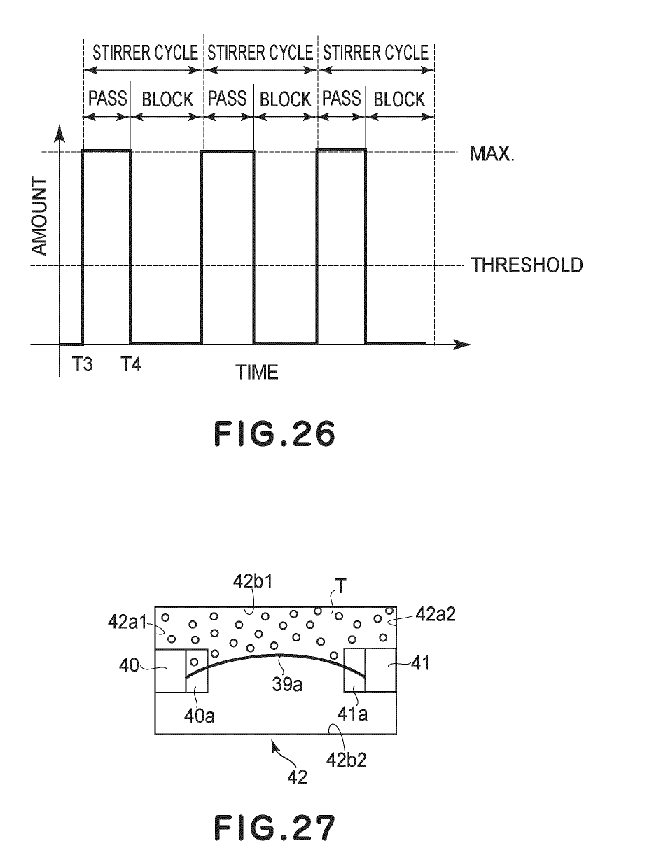

FIGS. 12(a) and 12(b) correspond to the case in which the amount of toner remaining in the toner storage chamber 18a is half the amount of toner remaining in the toner storage chamber 18a when the development unit 4 is in the state shown in FIGS. 11(a) and 11(b). FIG. 26 shows the relationship (waveform) between the amount of detection light L which the phototransistor (unshown) received when the amount of the toner remaining in the toner storage chamber 18a was as shown in FIGS. 12(a) and 12(b), and the elapsed time.

The angle by which the toner stirring member 22 rotates during the period between a point T3 in elapsed time (FIG. 26) at which the detection light L begins to be blocked again as shown in FIG. 12(a), and a point T4 (FIG. 26) in elapsed time at which the detection light L begins to transmit again though the space between the transparent members 40 and 41 as shown in FIG. 12(b) is θ.

As described above, the amount of toner remaining in the toner storage chamber 18a is estimated based on the fact that the angle (θ) by which the toner stirring member 22 rotates from the moment the detection light L begins to be blocked to the moment the detection light L begins to be allowed to transmit again through the space between the transparent members 40 and 41 is affected by the amount of toner remaining in the toner storage chamber 18a.

According to the present invention, the body of toner T, which is being pushed up along the smooth inward surface of the portion W2 of the toner storage chamber wall, being therefore stable in behavior, is used to block the detection light L, or allow the detection light L to transmit through the space between the transparent members 40 and 41. Therefore, the length of time the detection light L remains blocked, and the length of time the detection light L is allowed to transmit through the space between the transparent members 40 and 41, are stable. Therefore, the amount of the toner remainder can be more precisely detected.

Further, in this embodiment, the detection light L which is transmitting through the space between the transparent members 40 and 41 is blocked by pushing up the toner in the toner storage chamber 18a along the portion W2 of the wall of the toner storage chamber 18a, which is tilted toward the axial line of the toner stirring member 22 relative to the vertical direction, by the rotational toner stirring member 22. Further, the transparent members 40 and 41 are attached to the portion W2 of the wall of the toner storage chamber 18a, which is tilted toward the axial line of the toner stirring member 22. Therefore, toner does not settle on the transparent members 40 and 41. Moreover, referring to FIG. 10, the development unit 4 is structured so that when the process cartridge is in its image forming position in the main assembly of the image forming apparatus, the point P of the inward surface of the toner storage chamber wall, which corresponds to the point in elapsed time at which the sweeping edge of the stirring sheet 22b becomes freed from the portion W2 of the toner storage chamber wall, is on the inward side of the vertical plane which coincides with the most inward edges of the transparent members 40 and 41, that is, the point P is closer to the rotational axis of the toner stirring member 22 than the most inward edges of the transparent members 40 and 41. Therefore, it does not occur that as the excessive portion of the body of toner T which is being conveyed by the toner stirring member 22 falls, it disturbs the detection light L. Therefore, it is ensured that the amount of the toner remainder in the toner storage chamber 18a is precisely detected.

### Embodiment 2

Next, the second embodiment of the present invention will be described.

Incidentally, the portions of the process cartridge and image forming apparatus in this embodiment, the description of which will be the duplication of the description of the counterparts in the first embodiment, will not be described here.

### [Process Cartridge]

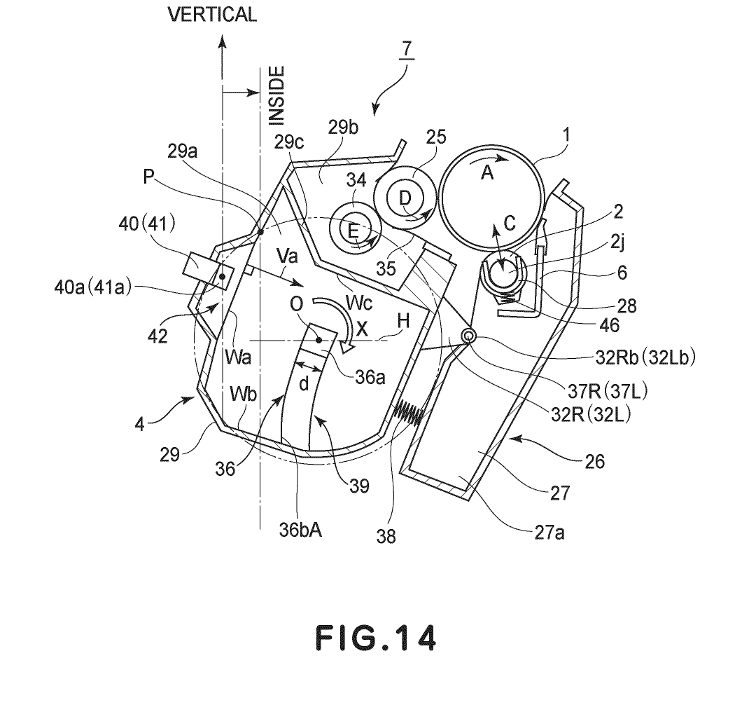

Referring to FIG. 14, the process cartridge 7 (7a-7d) in this embodiment will be described. FIG. 14 is a schematic cross-sectional view of the process cartridge 7 (7a-7d) in this embodiment, which is in its image forming position in the main assembly 100 of the electrophotographic image forming apparatus (FIG. 1).

In this embodiment, a cartridge 7a, which contains yellow toner, a cartridge 7b, which contains magenta toner, a cartridge 7c, which contains cyan toner, and a cartridge 7d, which contains black toner, are the same in structure.

The process cartridge 7 (7a-7d) is made up of a photosensitive member unit 26 (26a-26d) and a development unit 4 (4a-4d). Next, the two units 26 and 4 will be described.

The photosensitive member unit 26 is provided with a photosensitive drum 1 (1a-1d), a charge roller 2 (2a-2d), and a cleaning member 6 (6a-6d).

To the cleaning means frame 27 of the photosensitive member unit 26, the photosensitive drum 1 is rotatably attached with interposition of a pair of unshown bearings. In the adjacencies of the peripheral surface of the photosensitive drum 1, the charge roller 2, and cleaning member 6 are disposed as descried above. As the residual toner is removed from the peripheral surface of the photosensitive drum 1 by the cleaning member 6, it falls into a chamber 27a for the removed residual toner. As the driving force from a driving motor (unshown) is transmitted to the photosensitive member unit 26, the photosensitive drum 1 is rotationally driven in the direction indicated by an arrow mark A in synchronism with the progression of the image forming operation.

To the cleaning means frame 27, a pair of charge roller bearings 28 are attached so that the bearings 28 are movable in the direction indicated by a double-headed arrow mark C, the theoretical extension of which coincides with the axial lines of the charge roller 2 and photosensitive drum 1. The shaft 2j of the charge roller 2 is rotatably borne by the pair of charge roller bearings 28, which are kept pressured toward the photosensitive drum 1 by a pair of pressure applying member 46.

The developing means frame 29 of the development unit 4 has a developer storage chamber 29a (which hereafter will be referred to as toner chamber) and a development chamber 29b. The toner chamber 29b stores toner. There is a development roller 25, as a developer bearing member, in the development chamber 29b. The development roller 25 rotates in contact with the photosensitive drum 1, in the direction indicated by an arrow mark D.

In this embodiment, the development chamber 29b is above the toner chamber 29a. The toner chamber 29a and development chamber 29b are in connection to each other, through a hole 29c, with which the partition wall between the two chambers 29b and 29a is provided.

The development roller 25 in the development chamber 29b is rotatably supported by a developing means frame 29. More specifically, the development roller 25 is supported at its lengthwise end portions by a pair of bearings (unshown) attached to the lengthwise ends of the developing means frame 29.

The development unit 4 is also provided with a developer supply roller 34 (which hereafter will be referred to as toner supply roller) and a development blade 35, which are in the adjacencies of the peripheral surface of the development roller 25. The toner supply roller 34 rotates in contact with the development roller 25 in the direction indicated by an arrow mark E. The development blade 35 is a blade for regulating in thickness the toner layer on the peripheral surface of the development roller 25.

Further, the toner chamber 29a of the developing means frame 29 is provided with a recess 42 which is recessed outward from the toner chamber 29, as will be described later in detail. This recess 42 is provided with a pair of transparent members 40 and 41 as developer remainder amount detecting members (which is means for detecting amount of developer (toner) remainder) for detecting the amount of the developer remaining in the toner chamber 29a. The transparent members 40 and 41 are provided with a light exit portion 40a, through which the detection light L exits from the transparent member 40, whereas the transparent member 41 has a light entrance portion 41a, through which the detection light L enters the transparent member 41, respectively.

Further, there is a developer stirring member 36 (which hereafter will be referred to as toner stirring member) for stirring the toner in the toner storage chamber 29a while conveying the toner to the abovementioned toner supply roller 34. The toner stirring member 36 is provided with a cleaning member 39 (which hereafter may be referred to transparent member cleaning member) for cleaning the light exit portion 40a and light entrance portion 41a.

The development unit 4 is pivotally connected to the photosensitive member unit 26. More specifically, the bearing members 32R and 32L are provided with holes 32Rb and 32La, and a pair of connective pins 37R and 37L are put through the holes 32Ra and 32La and the corresponding holes of the photosensitive member unit 26 so that the development unit 4 is pivotally movable relative to the photosensitive member unit 26. When the process cartridge 7 is being used for image formation, the development unit 4 is under the pressure from compression springs 24 for pressing the development unit 4. Therefore, during an image forming operation, the process cartridge 7 is pivoted about the connective pins 37R and 37L in the direction indicated by an arrow mark F, whereby the development roller 25 is placed in contact photosensitive drum 1.

[Structure of Toner Stirring Member, Structure of Member for Cleaning Light Exit and Entrance Portions, Toner Remainder Amount Detection Based on Amount of Light Transmission]

Next, referring to FIGS. 14-18, the structure of the toner stirring member 36, structure of the member for cleaning the light exit portion and light entrance portion of the transparent members 40 and 41, respectively, and detection of toner remainder amount based on the amount of light transmission, will be described.

Referring to FIG. 14, there is a toner stirring member 36 in the toner chamber 29a which stores toner. The toner in the toner chamber 29a is conveyed to a toner supply roller 34 through the hole 29c, by rotating the stirring member 36 in the direction X. Incidentally, also in this embodiment, the development unit 4 is structured so that the point P at which the sweeping edge of the toner stirring member 36 is freed from the internal surface of the portion Wa of the toner storage chamber wall, is on the inward side of the vertical plane which coincides with the most inward edges of the transparent member 40 and 41, that is, the vertical plane which coincides with the point P is closer to the rotational axis O of the toner stirring member 36 than the vertical plane coinciding with the most inward edges of the transparent members 40 and 41.

Referring to FIG. 14, the wall W of the toner chamber 29a has a bottom portion Wb and a lateral portion Wa, The bottom portion Wb is the portion which is at the bottom when the cartridge is properly set in its image forming position, that is, when the attitude of the cartridge is as shown in FIG. 14. In terms of the rotational direction of the toner stirring member 36, the lateral Wa is on the downstream side of the bottom portion Wb. It is tilted toward the axial line of the toner stirring member 36, relative to the vertical direction. It is the lateral portion Wa that is provided with the recess 42 which is provided with the pair of toner remainder amount detecting member, that is, the transparent members 40 and 41, as will be described later in later. Further, the wall W of the toner chamber 29a has a portion Wc, that is, the rest of the wall W of the toner chamber 29a, which is between the abovementioned tilted portion Wa (lateral portion) and portion Wb (bottom portion) in terms of the rotational direction of the toner stirring member 36, and connects the two portions Wa and Wb of the wall W of the toner chamber 29a.

As the toner stirring member 36 is rotated in the toner chamber 29a, the sweeping edge 36bA moves in contact with the bottom portion Wb, lateral portions Wa (tilted portion), etc., as will be described later in detail. Thus, the toner T in the toner chamber 29a is guided to the hole 29c along the bottom portion Wb, and then, along the portion Wa.

More specifically, as the toner stirring member 36 is rotated, a part of the body of toner T in the toner chamber 29a fails to be guided into the hole 29c, that is, it falls from the toner stirring member 36 and settles back in the bottom portion of the toner chamber 29a, whereas the other part is guided inward of the toner chamber 29a, along the portion Wc of the toner storage chamber wall, by the toner stirring member 36.

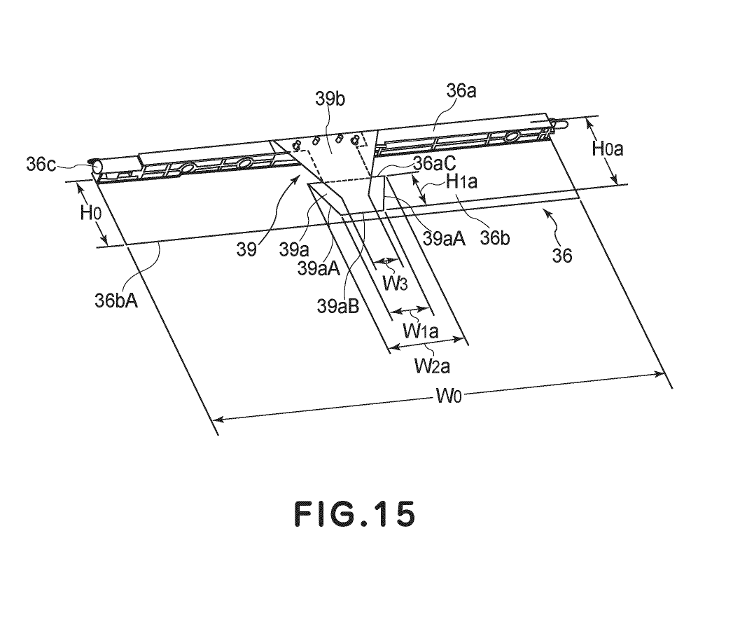

Referring to FIG. 15, the toner stirring member 36 is made up of a shaft 36a and a stirring sheet 36b. The shaft 36a is molded of a resinous substance. The stirring sheet 36b is the very portion of the toner stirring member 36 that stirs toner. It is a rectangular sheet made of flexible resinous sheet. Its longer edges, that is, the edges parallel to the lengthwise direction of the shaft 36a, have a length of W0, and its shorter edges, that is, the edges parallel to the radius direction of the sweeping area of the stirring sheet 36b, that is, the distance from the rotational axis of the shaft 36a to the sweeping edge of the stirring sheet 36b, have a length of H0. The stirring sheet 36b is attached to the shaft 36a by one of the longer edges.

In terms of the stirring member rotation direction, the cleaning member 39 for cleaning the light exit surface 40a and light entrance surface 41a is on the downstream side of the stirring sheet 36b. The cleaning member 39 is made up of a wiping sheet 39a and an auxiliary wiping sheet 39b. The wiping sheet 39a is a flexible sheet for wiping away the toner having adhered to the light exit surface 40a, and the light entrance surface 41a. The auxiliary wiping sheet 39b is a member which assists the wiping sheet 39a in cleaning the light exit surface 40a and light entrance surface 41a. The auxiliary wiping sheet 39b is attached to the shaft 36a by one of its edges parallel to the shaft 36a. It is also attached to the wiping sheet 39a by the other edge parallel to the shaft 36a. That is, the auxiliary wiping sheet 36b plays the role of the supporting member for attaching the wiping sheet 39a to the shaft 36a.

Referring to FIGS. 14 and 15, in this embodiment, the shaft 36a is rectangular in cross section. The toner stirring member 36 (stirring sheet 36b) is attached to one of the surfaces of the shaft 36a. The transparent member cleaning member 39 (more specifically, auxiliary wiping sheet 39b) is attached to the opposite surface of the shaft 36a from the surface to which the toner stirring member 36 is attached. Therefore, in terms of the rotational direction of the toner stirring member 36, the transparent member cleaning member 39 is on the downstream side relative to the toner stirring member 36 by a distance equivalent to the measurement (d) of the shaft 36a (FIG. 14).

To describe in more detail, the wiping sheet 39a is in the form of an isosceles trapezoid. That is, the wiping edge 39aB of the wiping sheet 39a, that is, the outward edge in terms of the radius direction of the sweeping area of the toner stirring member 36 is narrower (W1a) than the edge 29aC, that is, the inward (other) edge (W2a) in terms of the abovementioned radius direction, which is closer to the shaft 36a by the height H1a (W1a<W2a). As will be described later in more detail, the pair of lateral edges 39aA of the trapezoidal wiping sheet 39a wipe away the toner having adhered to the light exit surface 40a and light entrance surface 41a, by coming into contact with the light exit surface 40a and light entrance surface 41a. Further, the distance H0a from the axial line of the shaft 36a to the wiping edge 39aB of the wiping sheet 39a is roughly the same in value as the abovementioned measurement H0 of the stirring sheet in terms of the radius direction of the sweeping area of the toner stirring member 36.

The stirring sheet 36b and wiping sheet 39a can be easily made of flexible resinous sheet, such as polyester film, polyphenylene sulfide film, or the like. The thickness of the stirring sheet 22b is desired to be in a range of 50-250 μm.

The force for driving the stirring member 36 is transmitted to the stirring member 36 by a driver gear (unshown) attached to one of the lengthwise ends of the shaft 36a; the shaft of the driver gear is inserted in the hole 36c, with which one of the lengthwise ends of the shaft 36a is provided, through the hole with which one of the lateral walls of the toner chamber 29a of the developing means frame 29 is provided.

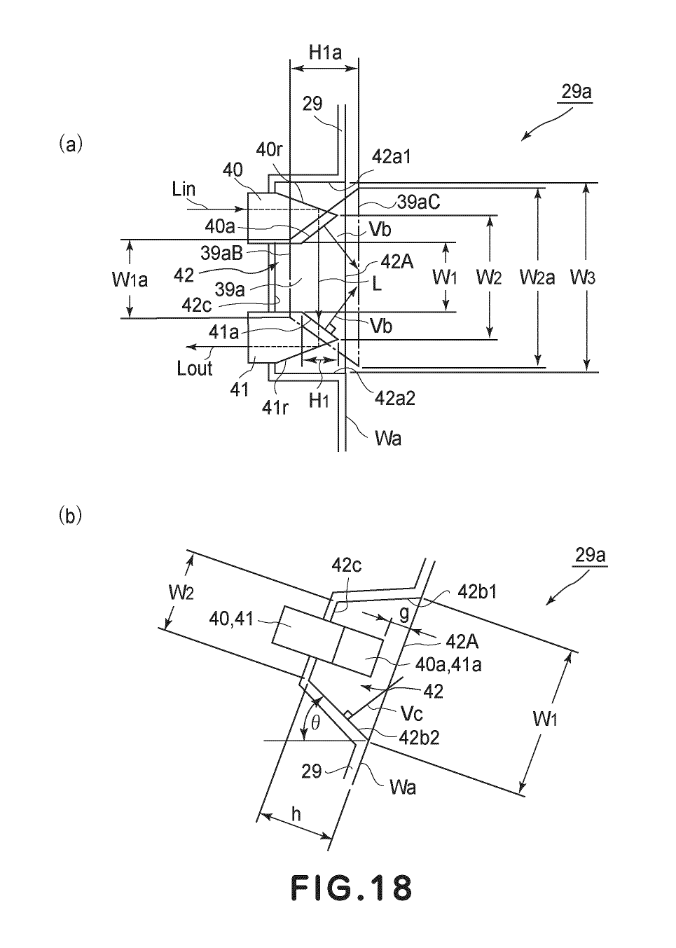

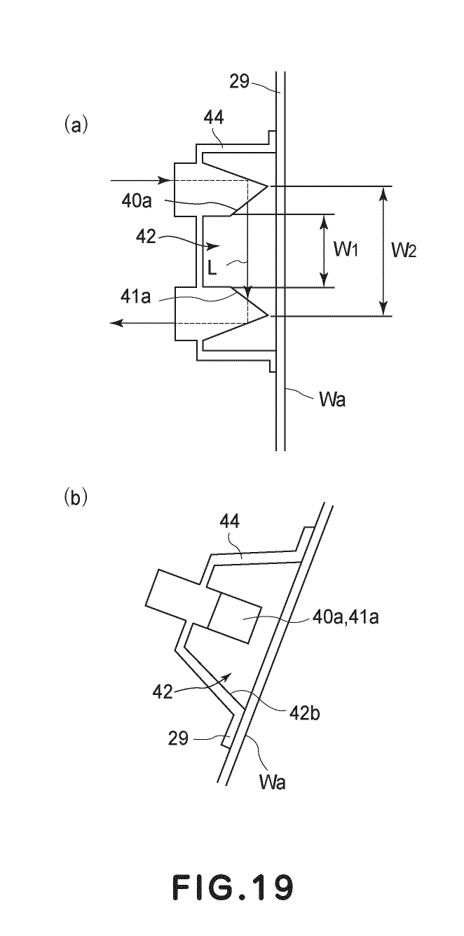

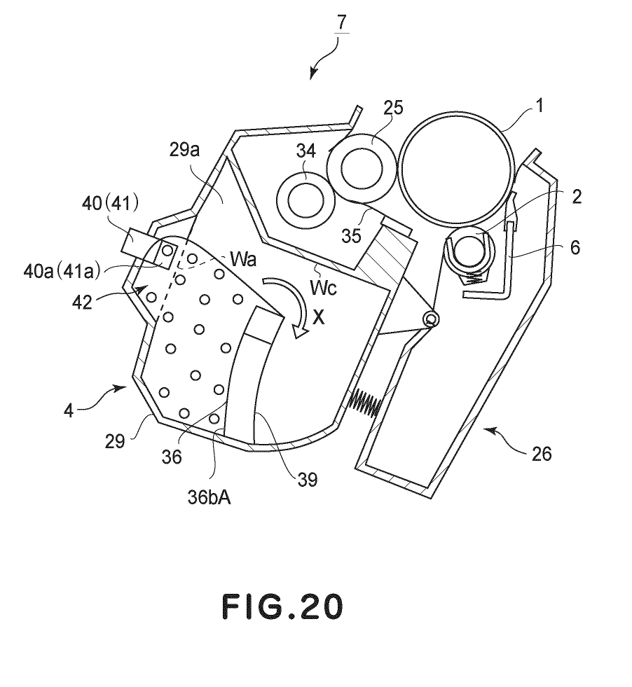

Further, referring to FIGS. 14 and 18(a), the light exit surface 40a and light entrance surface 41a for detecting the amount of the toner remainder, based on the amount of light transmission, are positioned so that they oppose each other, in terms of the direction parallel to the rotational axis of the toner stirring member 36. The light exit surface 40a is an integral part of the transparent member 40 which guide the detection light Lᵢₙ emitted from the LED (unshown), as a light emitting portion, with which the main assembly 100A of the electrophotographic image forming apparatus is provided, into the recess 42 (that is, toner chamber 29a).

The light exit surface 41a is an integral part of the transparent member 41, which guides the detection light Lₒᵤₜ to the phototransistor (unshown), as the light receiving portion, with which the main assembly 100A of the electrophotographic image forming apparatus is provided, after the detection light L transmits through the recessed portion 42. Incidentally, the transparent members 40 and 41 may be integrated into a single component.

As the cleaning member 39 rotates, not only do the wiping sheet 39a and auxiliary wiping sheet 39b of the cleaning member 39 clean the light exit surface 40a and light entrance surface 41a, but also, block the detection light L while they are wiping the light exit surface 40a and light entrance surface 41a.

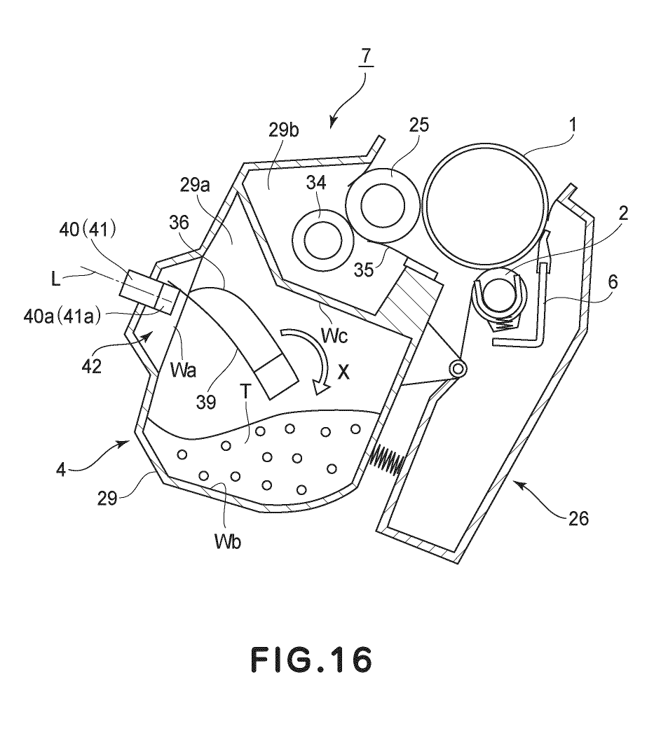

FIG. 16 is a cross-sectional view of the process cartridge 7 immediately after the cleaning of the light exit surface 40a and light entrance surface 41a, respectively, by the cleaning member 39. When the process cartridge 7 is in the state shown in FIG. 16, the detection light L transmits through the recess 42, and is detected by the light receiving portion in the main assembly of the image forming apparatus, through the light exit surface 41a.

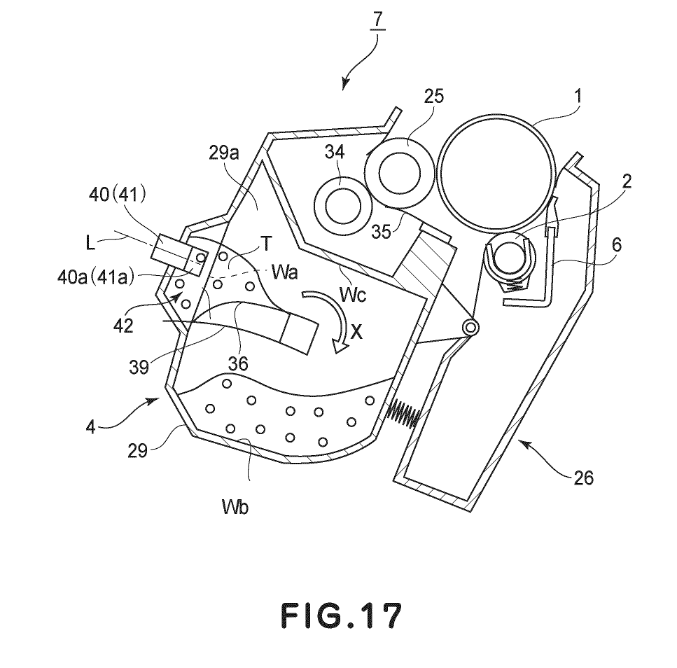

On the other hand, FIG. 17 is a cross-sectional view of the process cartridge 7 immediately before the light exit surface 40a and light entrance surface 41a, respectively, are cleaned by the cleaning member 39. When the process cartridge 7 is in the state shown in FIG. 17, the detection light L is blocked in the recess 42 by the body of toner T, which is being conveyed by the toner stirring member 36, and therefore, it does not reach the light exit surface 41a. Thus, it is not received by the light receiving portion in the main assembly of the image forming apparatus.

With the employment of the above described structural arrangement, the amount of the toner remaining in the toner chamber 29a can be estimated based on the length of time the detection light L transmits through the toner chamber 29a (that is, recessed portion 42), that is, the length of time the detection light L is received by the light receiving portion of the image forming apparatus, per rotation of the toner stirring member 36.

### [Position and Shape of Light Exit Surface and Light Entrance Surface]

At this time, referring to FIGS. 14 and 18, the position and shape of the light exit surface 40a and light entrance surface 41a of the pair of transparent members 40 and 41, respectively, will be described in more detail.

In this embodiment, the amount of the toner remainder is detected by the pair of transparent members 40 and 41, based on the light transmission through the transparent members 40 and 41.

That is, referring to FIG. 18, as described above, according to the toner remainder amount detecting means in this embodiment, the detection light Lᵢₙ emitted from the light emitting portion (unshown), such as a LED, attached to the main assembly of the image forming apparatus is guided to the transparent member 40. Entering the transparent member 40, the detection light Lᵢₙ is deflected by 90°, by the reflective surface 40r of the transparent member 40, being thereby guided toward the light exit surface 40a of the transparent member 40, and exits from the transparent member 40 through the light exit surface 40a. Exiting through the light exit surface 40a, the detection light L travels through the process cartridge, and is guided into the light entrance surface 41a of the transparent member 41, that is, the other transparent member, which opposes the transparent member 40. Entering the transparent member 41, the detection light L is deflected by 90° by the reflective surface 41r of the transparent member 41. Then, the detection light L travels through the transparent member 41, and exits from the transparent member 41, that is, exits from the process cartridge. Exiting from the process cartridge, the detection light Lₒᵤₜ is guided to the light receiving portion, such as a phototransistor, attached to the main assembly of the image forming apparatus.

Referring also to FIG. 18, in this embodiment, the transparent members 40 and 41 are structured and positioned (attached to development unit 4) so that the distance W2 between the inward edges of the mutually opposing light exit surface 40a and light entrance surface 41a is greater than the outward edges of the mutually opposing light exit surface 40a and light entrance surface 41a (that is, W2>W1).

Therefore, in order to ensure that the tilted light exit surface 40a and light entrance surface 41a, which oppose each other, are satisfactorily cleaned by the wiping sheet 39a of the cleaning member 39, the wiping sheet 39a is rendered trapezoidal, as described above. Also in order to ensure that the wiping sheet 39a of the cleaning member 39 cleans the light exit surface 40a and light entrance surface 41a by elastically contacting the surfaces 40a and 41a, the wiping sheet 39a is rendered slightly larger than the trapezoidal area which the mutually opposing light exit surface 40a and light entrance surface 41a form as shown in FIG. 18(a).

Depending on the positional relationship among the light exit surface 40a, light entrance surface 41a, and toner stirring member 36, the toner on the toner stirring member 36 and the toner on the cleaning member 39 sometimes fall from the toner stirring member 36 and/or cleaning member 39, respectively, and adheres to the light exit surface 40a and light entrance surface 41a, immediately after the cleaning of the surfaces 40a and 41a by the cleaning member 39. Therefore, the detection light L is sometimes blocked by the toner fell from the stirring member 36 and/or cleaning member 39 immediately after the cleaning. Further, the detection light L is sometimes blocked because the toner particles floating in the toner chamber 29a adhere to the light exit surface 40a and light entrance surface 41a.

Thus, in this embodiment, in order to prevent the problem that the toner, which fell from the toner stirring member 36 and/or cleaning member 39, adhere to the light exit surface 40a and light entrance surface 41a, the following structural arrangement is employed.

That is, referring to FIG. 14, the transparent members 40 and 41 are attached to the portion Wa of the toner chamber wall, which will be above the horizontal plane H which coincides with the rotational axis O of the stirring member 36 when the process cartridge is in its image forming position in an image forming apparatus. Further, the portion Wa of the wall of the toner chamber 29a is tilted so that a straight line Va drawn perpendicularly and inwardly from the portion Wa is on the bottom side of the horizontal plane which coincides with the point of the portion Wa, from which the straight line Va is drawn. Further, referring to FIG. 18, the development unit 4 is structured so that a straight line Vb drawn inward of the toner chamber 29a from the light exit surface 40a (41a), and perpendicularly to the light exit surface 40a (41a), is under the horizontal plane which coincides with the point of the light exit surface 40a, from which the straight line Vb is drawn.

Incidentally, the angle of the top surface of the body of developer in the toner chamber 29a is affected by the angle of the axial line of the stirring member during the mounting of the process cartridge. Therefore, in order to reduce the effect of the inclination of the surface of the body of developer in the toner chamber 29a, the light exit surface 40a and light entrance surface 41a are desired to be positioned roughly at the middle of the toner chamber 29a in terms of the direction parallel to the axial line of the stirring member 36.

### [Improvement in Blocking of Detection Light by Toner]

In this embodiment, the toner chamber 29a is provided with the recess 42, which is recessed outward from the toner chamber 29a in the radius direction of the sweeping area of the stirring member 36. More specifically, the portion Wa of the wall W of the toner chamber 29a, which is between the portions Wb and Wc of the wall W of the toner chamber 29a, is provided with the recess 42. As will be evident from FIG. 18, the recess 42 is a boxy space which opens to the toner chamber 29a, and the opening of which has a size of w1 (length of edge perpendicular to axial line of toner stirring member)×w3 (length of edge parallel to axial line of toner stirring member).

That is, the recess 42 has lateral walls 42a1 and 42a2 which oppose each other in terms of the direction parallel to the rotational axis of the toner stirring member 36, and walls 42b1 and 42b2 which oppose each other in terms of the rotational direction of the toner stirring member 36. Further, the recess 42 has the bottom wall which holds a distance h from the plane of the opening 42A of the recess 42, that is, the border between the recess 42 and toner chamber 29a, and has a size of w2×w3. In this embodiment, the transparent members 40 and 41 are attached to the bottom wall 42c of the recess 42.

Also referring to FIG. 18, in this embodiment, the wall of the recess 42 is an integral part of the portion Wa (tilted portion) of the wall W of the toner chamber 29a (that is, development means frame 29). However, the wall of the recess 42, and the pair of transparent members 40 and 41 may be integrally formed as a single piece, which is attachable to the portion Wa of the wall W of the toner chamber 29a (that is, developing means frame 29).

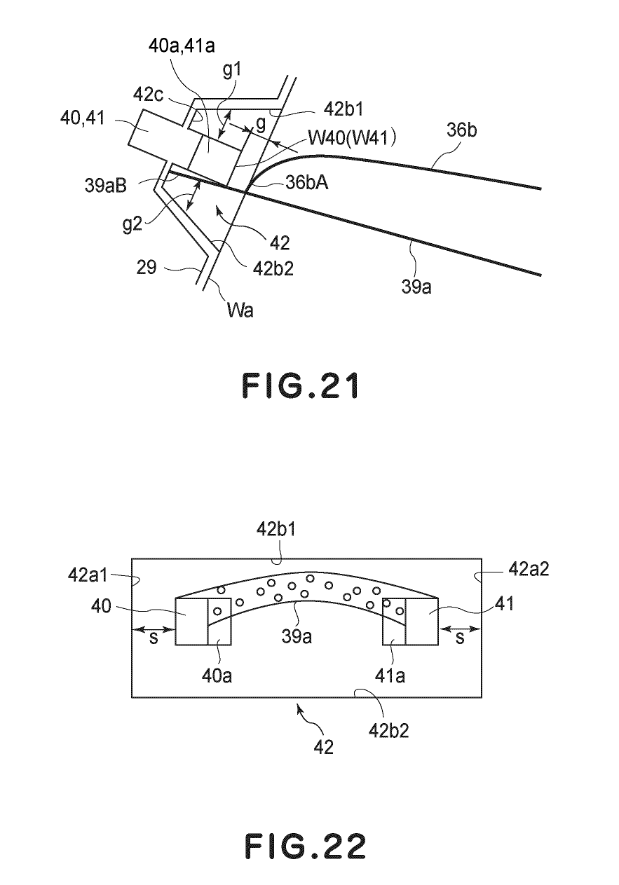

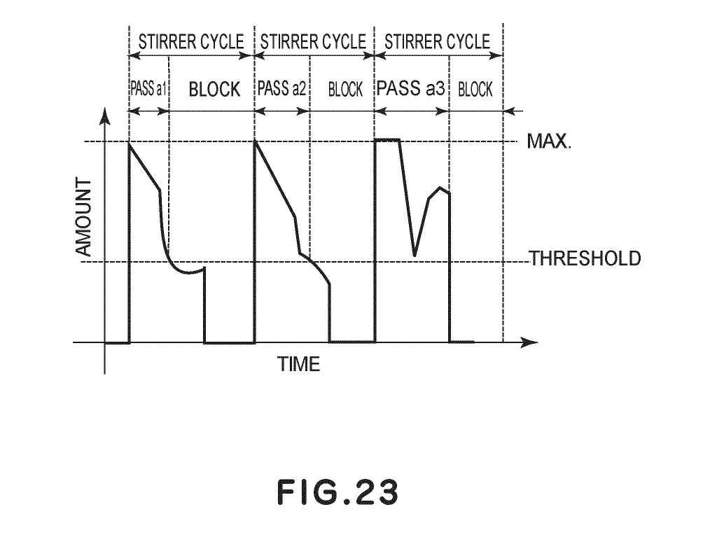

The development unit 4 (recess 42) is structured so that there is a gap g between the most inward edge of the surface 40a (41a) of the transparent member 40 (41) and the plane of the opening 42A of the recess 42 (FIGS. 18(b) and 21). The value of the gap g has only to be such that the transparent members 40 and 41 is prevented from protruding beyond the plane coinciding the inward surface of the portion Wa of the toner chamber wall. That is, the gap g is to be provided to prevent the problem that the toner stirring member 36 deform by hanging up on the transparent members 40 and 41. Also in this embodiment, the development unit 4 (recess 42) is structured so that there is a certain amount of distance between the light exit surface 40a (and light entrance surface 41a) and the bottom wall 42c. This structural arrangement is made to prevent the problem that sometimes, the amount of the toner remainder cannot be accurately detected because toner sometimes fails to reach the adjacencies of the bottom wall 42c.

Thus, in this embodiment, the above described structural arrangement is employed to ensure that the detection light L remains satisfactorily blocked until the sweeping edge 36bA of the stirring sheet 36b begins to move through the adjacencies of the light exit surface 40a and light entrance surface 41a, and also, to better control the toner in its behavior while the sweeping edge 36bA of the stirring sheet 36b moves through the adjacencies of the light exit surface 40a and light entrance surface 41a.

However, regarding the blocking of the detection light L while the sweeping edge 36bA of the stirring sheet 36b moves through the adjacencies of the light exit surface 40a and light entrance surface 41a, because toner slips through the gap between the sweeping edge 36bA of the stirring sheet 36b and the portion Wa of the toner chamber wall, which has the recess 42, it is still difficult to keep the detection light L satisfactorily blocked while the sweeping edge 36bA of the stirring sheet 36b is moving through the abovementioned area.

More specifically, referring to FIG. 21, while the sweeping edge 36bA of the stirring sheet 36b moves through the adjacencies of the light exit surface 40a and light entrance surface 41a, the wiping sheet 39a, which is on the downstream side of the stirring sheet 36b in terms of the rotational direction of the toner stirring member 36, enters the space between the light exit surface 40a and light entrance surface 41a. Further, the development unit 4 (toner chamber 29a) is structured so that the wiping sheet 39a for cleaning the light exit surface 40a and light entrance surface 41a comes into contact with the sweeping edge 36bA of the stirring sheet 36b when the wiping sheet 39a enters the space between the light exit surface 40a and light entrance surface 41a. Therefore, while the stirring sheet 36b moves through the space between the light exit surface 40a and light entrance surface 41a, the gap g between the sweeping edge 36bA of the stirring sheet 36b, and the portion Wa of the wall W of the toner chamber 29a, which corresponds to the recess 42, is covered by the wiping sheet 39a. Therefore, this embodiment is superior to the first embodiment in terms of keeping the detection light L satisfactorily blocked while the sweeping edge 36bA of the stirring sheet 36b move through the adjacencies of the light exit surface 40a and light entrance surface 41a.

Further, because the development unit 4 (toner chamber 29a) is structured so that the wiping sheet 39a for cleaning the light exit surface 40a and light entrance surface 41a comes into contact with the sweeping edge 36bA of the stirring sheet 36b when the wiping sheet 39a enters the space between the light exit surface 40a and light entrance surface 41a, and also, so that the wiping sheet 39a begins to clean the light exit surface 40a and light entrance surface 41a the moment the body of toner T, which is being conveyed by the stirring sheet 36b, finishes moving through the space between the light exit surface 40a and light entrance surface 41a. Therefore, it is possible to reduce the problem that because the blockage of the detection light and the transmission of the detection light through the toner chamber (recess) are affected by the variation in the amount by which toner adheres or remains adhered to the light exit surface 40a and light exit surface 41a, the amount of the toner remaining in the toner chamber cannot be accurately detected.

### [Improvement of Wiping Performance of Cleaning Member]

Referring to FIGS. 15, 18, and 21, the pair of light exit surface 40a and light entrance surface 41a, transparent members 40 and 41, recess 42, and cleaning member 39 will be described in more detail regarding their shape.

The cleaning member 39 cleans the light exit surface 40a and light entrance surface 41a by being moved through the space between the light exit surface 40a and light entrance surface 41a, which are aligned in the direction parallel to the rotational axis of the toner stirring member 36.

The shape of the sheet stirring member 36 and cleaning member 39, and the recess 42, are as described above with reference to FIGS. 15 and 18.

In order for the wiping sheet 39a to satisfactorily wipe clean the light exit surface 40a and light entrance surface 41a, the rigidity of the wiping sheet 39a in terms of the vertical direction needs to greater than a certain value. However, if the piping sheet 39a is excessively increased in rigidity, the wiping sheet 39a cannot be moved into the space between the light exit surface 40a and light entrance surface 41a. Thus, in order to allow the wiping sheet 39a to enter the space between the light exit surface 40a and light entrance surface 41a, the rigidity of the wiping sheet 39a in terms of the direction parallel to the circumferential direction of the sweeping area of the toner stirring member 36 needs to be greater than the rigidity of the wiping member 39a in terms of the direction perpendicular to the light exit surface 40a and light entrance surface 41a.

Therefore, in this embodiment, in order to add to the rigidity of the wiping sheet 39a in terms of the circumferential direction of the sweeping area of the toner stirring member 36, the cleaning member 39 is provided with the auxiliary wiping sheet 39b, which is positioned on the downstream side of the wiping sheet 39a in terms of the rotational direction of the stirring member.

The width W3 of the edge of the auxiliary wiping sheet 39b on the wiping sheet side is less than the width W1a of the wiping edge 39aB of the wiping sheet 39a, which is perpendicular to the light exit surface 40a and light entrance surface 41a (W3<W1a). Further, the auxiliary wiping sheet 39b is shaped so that the width W3 is less than the shortest distance W1 between the light exit surface 40a and light entrance surface 41a (W3<W1).

Further, referring to FIG. 18, the light exit surface 40a and light entrance surface 41a are tilted so that their inward edges in terms of the radius direction of the sweeping area of the toner stirring member 36, is longer than their outward edges (W1<W2). Therefore, the wiping sheet 39a is shaped so that the its inward edge 39aC, in terms of the radius direction of the stirring member 36, is longer than its outward edge 39aB (W2a>W1a).

The wiping sheet 39a is shaped and sized to ensure that even if the wiping sheet 39a deforms and/or creeps, or the like problems occur, it can still wipe clean the light exit surface 40a and light entrance surface 41a across their entire range in terms of the circumferential direction of the sweeping area of the toner stirring member 36. That is, the wiping sheet 39a is rendered long enough, in terms of the radius direction of the sweeping area of the toner stirring member 36, to enter the portion of the recess 42, which is between the light exit surface 40a and light entrance surface 41a, deep enough to reach the bottom wall 42c of the recess 42.

Further, in order to ensure that the wiping sheet 39a wipes the light exit surface 40a and light entrance surface 41a across their entire range in terms of the rotational direction of the toner stirring member 36, a gap g1, which is the gap between the transparent member 40 (41) and the lateral wall 42b1, which is the downstream wall of the recess 42 in terms of the rotational direction of the toner stirring member 36, and a gap g2, which is the gap between the transparent member 40 (41) and the lateral wall 42b2, which is the upstream wall of the recess 42 in terms of the rotational direction of the toner stirring member 36, are rendered large enough for the wiping sheet 39a to satisfactorily wipe the light exit surface 40a and light entrance surface 41a across their entire ranges in terms of the rotational direction of the toner stirring member 36.

### [Prevention of Toner Adhesion After Wiping of Light Exit Surface and Light Entrance Surface by Cleaning Member]

Referring to FIG. 22, while the wiping sheet 39a moves between the light exit surface 40a and light entrance surface 41a, it is kept deformed by the light exit surface 40a and light entrance surface 41a, and there is toner T on the wiping sheet 39a.

As soon as the wiping sheet 39a moves past the space between the light exit surface 40a and light entrance surface 41a, the wiping sheet 39a is freed from the restriction placed on the wiping sheet 39a by the light exit surface 40a and light entrance surface 41a, and therefore, it springs back into its normal shape because of its resiliency. As a result, the toner T on the wiping sheet 39a is catapulted downward in terms of the rotational direction of the toner stirring member 36, in the recess 42.

If there is no space between the lateral wall 42a1 and transparent member 40, and between the lateral wall 42a2 and transparent member 41 (FIG. 27), the toner T on the wiping sheet 39a falls through the space between the light exit surface 40a and light entrance surface 41a after the cleaning of the light exit surface 40a and light entrance surface 41a. As the toner T falls, it sometimes adheres again to the light exit surface 40a and light entrance surface 41a.

Thus, in this embodiment, in order to prevent the problem that after the toner T is wiped away from the light exit surface 40a and light entrance surface 41a, it adheres again to the light exit surface 40a and light entrance surface 41a, a space S is provided between the transparent members 40 and 41, and lateral walls 42a1 and 42a2, respectively, of the recess 42, as shown in FIG. 22. With the provision of the space S between the transparent members 40 and 41, and lateral walls 42a1 and 42a2, respectively, of the recess 42, the toner borne on the wiping sheet 39a while the wiping sheet 39a moves between the light exit surface 40a and light entrance surface 41a falls through the gaps S between the transparent members 40 and 41, and lateral walls 42a1 and 42a2, respectively, of the recess 42. Therefore, when the wiping sheet 39a moves out of the space between the light exit surface 40a and light entrance surface 41a, there remains only a small amount of toner on the wiping sheet 39a.

The problem that the amount of the toner remainder in the toner chamber 29a is inaccurately detected because of the variation in the amount of the toner which adheres again to the light exit surface 40a and light entrance surface 41a after the light exit surface 40a and 41a are cleaned, can be reduced by reducing the amount by which toner T remains on the wiping sheet 39a when the wiping sheet 39a moves out of the space between the light exit surface 40a and light entrance surface 41a, that is, when the wiping sheet 39a kept deformed while moving between the light exit surface 40a and light entrance surface 41a is allowed to spring back into its normal shape.

Further, if the body of toner T, which entered the recess 42 during the period in which the detection light L was blocked, remains in the recess 42 even after the passage of the cleaning member 39 through the space between the light exit surface 40a and light entrance surface 41a, the toner sometimes adheres to the light exit surface 40a and light entrance surface 41a, and therefore, blocks the detection light L, after the cleaning of the light exit surface 40a and light entrance surface 41a.

The lateral wall 42b2 of the recess 42, that is, the lateral wall of the recess 42, which is on the bottom side, and on the upstream side in terms of the rotational direction of the toner stirring member 36 (FIG. 18), is tilted by the angle of θ, the value of which is large enough to cause the toner T to fall into the toner chamber 29a. This structural arrangement is for preventing the toner T from remaining in the recess 42 after the cleaning member 39 moves between the light exit surface 40a and light entrance surface 41a.

As described above, not only can this embodiment offer the same effects as the first embodiment, but also, can prevent the problem that during the period in which the detection light L is to be allowed to transmit through the space between the light exit surface 40a and light entrance surface 41a, the toner adheres to the light exit surface 40a and light entrance surface 41a immediately after the cleaning of the light exit surface 40a and light entrance surface 41a. On the other hand, the toner in the toner chamber 29a is moved into the light passage L by the stirring member 36 to block the detection light L. Therefore, the length of time the detection light L remains blocked is not affected by the change in the fluidity of the toner. Further, the light exit surface 40a and light entrance surface 41a are more efficiently wiped clean by the cleaning member 39.

In the foregoing examples, the use has been made with a toner remainder amount detecting means of the light transmission type, but the present invention is no limited to the toner remainder amount detecting means of this type, and those utilizing electrostatic capacity is usable.

According to the present invention, the developer detecting member is attached to the portion of the developer storage chamber wall, along which the developer stirring member conveys upward the developer in the developer storage chamber into the development chamber located on top of the developer storage chamber. Therefore, the amount of the developer remaining in the developer storage chamber can be detected while the body of developer is stable. Therefore, the amount of the developer remainder can be more precisely detected. Further, the developer remainder amount detecting method based on the amount of light transmission is employed. Therefore, the amount of the developer remainder can be detected with the use a small number of components which are inexpensive. Therefore, it is possible to provide a developing apparatus, a process cartridge, and an electrophotographic image forming apparatus, which are significantly lower in cost than those in accordance with the prior art.

While the invention has been described with reference to the structures disclosed herein, it is not confined to the details set forth, and this application is intended to cover such modifications or changes as may come within the purposes of the improvements or the scope of the following claims.

This application claims priority from Japanese Patent Applications Nos. 022466/2007 and 291356/2007 filed Jan. 31, 2007 and Nov. 8, 2007, respectively which are hereby incorporated by reference.

What is claimed is:

1. A developing apparatus for use with an electrophotographic image forming apparatus, said developing device comprising:
a developer accommodating chamber for accommodating a developer;
a developer chamber including the developer carrying member for carrying and feeding a developer supplied from said developer accommodating chamber to develop an electrostatic latent image formed on an electrophotographic photosensitive member;
a developer stirring member, rotatably provided in said developer accommodating chamber, for stirring the developer in said developer chamber then, supplying the developer from said developer accommodating chamber into said developer chamber through an opening formed in an upper part of said developer accommodating chamber;
a wall surface, provided in said developer accommodating chamber, for being contacted by a free end portion of said developer stirring member while said developer stirring member is moving, wherein said developer stirring member lifts the developer toward said opening along said wall surface in said developer accommodating chamber;
a developer detector for detecting a remaining amount of the developer;
wherein a position where the free end portion of said developer stirring member separates from said wall surface is above said developer detector and inside said developer accommodating chamber.

2. An apparatus according to claim 1, wherein said developer detector is disposed above a rotation axis of said developer stirring member.

3. An apparatus according to claim 1, wherein said developer detector includes a light emergent portion from which detecting light emerges, and an incident portion for receiving the detecting light emergent from said emergent portion.

4. An apparatus according to claim 1, wherein said developer stirring member includes a shaft member, and a flexible sheet having one end mounted in said shaft member and the other end contactable to said wall surface.

5. An apparatus according to claim 4, wherein said detector is provided in a recess provided in said wall surface.

6. An apparatus according to claim 5, wherein said emergent portion and said incident portion are provided at positions away from a bottom surface of said recess and not beyond said wall surface.

7. A process cartridge detachably mountable to a main assembly of an electrophotographic image forming apparatus, said process cartridge comprising:
an electrophotographic photosensitive member on which an electrostatic latent image is formed;
a developer accommodating chamber for accommodating a developer;
a developer chamber including the developer carrying member for carrying and feeding a developer supplied from said developer accommodating chamber to develop said electrostatic latent image formed on an electrophotographic photosensitive member;
a developer stirring member, rotatably provided in said developer accommodating chamber, for stirring the developer in said developer chamber then, supplying the developer from said developer accommodating chamber into said developer chamber through an opening formed in an upper part of said developer accommodating chamber, when said process cartridge is mounted to the main assembly of the electrophotographic image forming apparatus;
a wall surface, provided in said developer accommodating chamber, for being contacted by a free end portion of said developer stirring member while said developer stirring member is moving, wherein said developer stirring member lifts the developer toward said opening along said wall surface in said developer accommodating chamber;
a developer detector for detecting a remaining amount of the developer;
wherein a position where the free end portion of said developer stirring member separates from said wall surface is above said developer detector and inside said developer accommodating chamber.

8. A process cartridge according to claim 7, wherein said developer detector is disposed above a rotation axis of said developer stirring member.

9. A process cartridge according to claim 7, wherein said developer detector includes an emergent portion from which detecting light emerges, and an incident portion for receiving the detecting light emergent from said emergent portion.

10. A process cartridge according to claim 7, wherein said developer stirring member includes a shaft member, and a flexible sheet having one end mounted in said shaft member and the other end contactable to said wall surface.

11. A process cartridge according to claim 10, wherein said detector is provided in a recess provided in said wall surface.

12. A process cartridge according to claim 11, wherein said emergent portion and said incident portion are provided at positions away from a bottom surface of said recess and not beyond said wall surface.

13. An electrophotographic image forming apparatus for forming an image on a recording material, said apparatus comprising:
(i) a developing device including,
a developer accommodating chamber for accommodating a developer,
a developer chamber including the developer carrying member for carrying and feeding a developer supplied from said developer accommodating chamber to develop an electrostatic latent image formed on an electrophotographic photosensitive member,
a developer stirring member, rotatably provided in said developer accommodating chamber, for stirring the developer in said developer chamber then, supplying the developer from said developer accommodating chamber into said developer chamber through an opening formed in an upper part of said developer accommodating chamber,
a wall surface, provided in said developer accommodating chamber, for being contacted by a free end portion of said developer stirring member while said developer stirring member is moving, wherein said developer stirring member lifts the developer toward said opening along said wall surface in said developer accommodating chamber,
a developer detector for detecting a remaining amount of the developer,
wherein a position where the free end portion of said developer stirring member separates from said wall surface is above said developer detector and inside said developer accommodating chamber; and
(ii) feeding means for feeding the recording material.

14. An electrophotographic image forming apparatus for forming an image on a recording material, said apparatus comprising:
(i) a process cartridge detachably mountable to said electrophotographic image forming apparatus, said process cartridge including,
an electrophotographic photosensitive member on which an electrostatic latent image is formed,
a developer accommodating chamber for accommodating a developer,
a developer chamber including the developer carrying member for carrying and feeding a developer supplied from said developer accommodating chamber to develop said electrostatic latent image formed on an electrophotographic photosensitive member,
a developer stirring member, rotatably provided in said developer accommodating chamber, for stirring the developer in said developer chamber then, supplying the developer from said developer accommodating chamber into said developer chamber through an opening formed in an upper part of said developer accommodating chamber, when said process cartridge is mounted to the main assembly of the electrophotographic image forming apparatus,
a wall surface, provided in said developer accommodating chamber, for being contacted by a free end portion of said developer stirring member while said developer stirring member is moving, wherein said developer stirring member lifts the developer toward said opening along said wall surface in said developer accommodating chamber,
a developer detector for detecting a remaining amount of the developer,
(ii) mounting means for detachably mounting said process cartridge;
(iii) feeding means for feeding the recording material.
